(19) United States
(12) Patent Application Publication
(10) Pub. No.: US 2003/0097421 A1
(43) Pub. Date: May 22, 2003

(54) System and method for directed delivery of information to end users

(76) Inventors: Allan D. Wille, Ottawa (CA); James J. Scott, Ottawa (CA); Peter J. Matthews, Ottawa (CA)

Correspondence Address: Cassan MacLean, Suite 401, 80 Aberdeen Street, Ottawa, ON, K1S 5R5, CA

(21) Appl. No.: 10/179,990

(22) Filed: Jun. 26, 2002

Related U.S. Application Data
(60) Provisional application No. 60/326,720, filed on Oct. 4, 2001.

(51) Int. Cl. G06F 15/16

(52) U.S. Cl. 709/217; 709/206

(57) ABSTRACT

Systems, devices, and methods related to information delivery systems which use a computer network. In one embodiment, an information delivery system application accesses a script file which contains first data identifying a first networked information source. The application communicates with the first networked information source to access second data stored at the first networked information source. The second data relates to information items stored at a second networked information source and at least a portion of this second data is presented to an end user using a non-obtrusive graphical user interface. Using the graphical user interface, the user can activate any portion of the second data presented. When this is activated, the end user is directed to the information item corresponding to the activated portion. The graphical user interface is provided with independent and separate sections, each of which corresponds to a different networked information source. The application has a script engine module which reads and interprets the script file, a communications module which communicates with the networked information sources, and a graphical user interface which presents the portion of the second data to the end user.

This application claims priority from U.S. provisional patent application No. 60/326,720 filed Oct. 4, 2001.

### FIELD OF THE INVENTION

The present invention relates to computer communications. The present invention is particularly applicable but not limited to systems and methods for automated delivery of information to selected end users by way of network communications.

### BACKGROUND TO THE INVENTION

The unprecedented increase in both activity and interest in the Internet has also led to a corresponding explosion in the number of people and businesses using the Internet. A significant portion of these individuals are online to access and to exploit the one major resource that the Internet offers—information. People “surf” the Internet to find information on everything and, in this pursuit of information, they invariably visit a few of their favourite websites for the latest information. These websites can be as information driven as a news centered site such as CNN.com™ or it can be retail driven such as a website hosted by a specific store, with the visitor checking on the latest merchandise on sale.

Unfortunately, the above scenario can be time consuming and difficult for both the end user and the website providers. End users have to repeatedly visit the websites to find any new information and website content providers have no means of delivering their content to end users who are interested.

Current technology only allows content providers to post their content on their website in the hope that interested end users will find these sites and, hopefully, return. End users, for their part, have to launch their web browser applications (such as Netscape Navigator™ or Microsoft's Internet Explorer™) to browse the content provider's websites.

Such applications, when operating, can consume large amounts of an end user's computer resources. Furthermore, current versions of such software require large areas of an end user's screen—thereby visually obscuring whatever other application the end user may be using. Essentially, when using such browsers, the end user has to choose between viewing the browser or the end user's other applications.

One method currently used by content providers to alert their potential consumers of new content/promotions is by sending mass, generally unsolicited emails. Such emails, termed as “spam”, are annoying to end users and can use up large chunks of transmission capacity. By annoying potential end users, the end result may be counterproductive.

Based on the above, a new network information delivery system is needed. Such a system, and the methods used by it, must be unobtrusive without any end user intervention. Furthermore, such a system, when active, must provide the end user with the information being delivered without significantly visually obscuring what other applications the end user may have operating.

### SUMMARY OF THE INVENTION

The present invention provides systems, devices, and methods related to information delivery systems which use a computer network. In one embodiment, an information delivery system application accesses a script file which contains first data identifying a first networked information source. The application communicates with the first networked information source to access second data stored at the first networked information source. The second data relates to information items stored at a second networked information source and at least a portion of this second data is presented to an end user using a non-obtrusive graphical user interface. Using the graphical user interface, the user can activate any portion of the second data presented. When this is activated, the end user is directed to the information item corresponding to the activated portion. The graphical user interface is provided with independent and separate sections, each of which corresponds to a different networked information source. The application has a script engine module which reads and interprets the script file, a communications module which communicates with the networked information sources, and a graphical user interface which presents the portion of the second data to the end user.

In a first aspect the present invention provides a system for retrieving information from a variety of information sources in a network and for use with at least one script file, the or each script file containing first data corresponding to a first one of said information sources, the system comprising:

a script engine module for interpreting said first data, said first data including location data for said first one of said information sources;

a communications module for retrieving second data from said first one of said information sources, said second data relating to information items stored on a second one of said information sources and said second data being processed to produce third data;

a user interface module for presenting said third data to a user, wherein the or each script file corresponds to said second one of said networked information sources.

In a second aspect the present invention provides a graphical user interface for use in a software application for information retrieval from at least one networked information source, the interface comprising:

a main section occupying a first portion of a user screen;

at least one subsidiary section, the or each subsidiary section occupying a portion of the user screen separate and independent from each other section, the or each subsidiary section corresponding to one networked information source wherein the or each subsidiary section contains at least one first indicia relating to a specific information item stored on a networked information source corresponding to said subsidiary section.

In a third aspect, the present invention provides a file readable by a computing device, the file being for use with an information retrieval application for retrieving data related to information items stored at an information source, the file comprising:

a source field containing address data relating to an address location, said network address location being a location where said data is stored;

a script field containing instructions for said application on how said data is to be processed.

In a fourth aspect the present invention provides a method for retrieving data from a first networked information source, the method comprising the steps of:

a) accessing a specific file corresponding to said first networked information source;

b) locating a portion of said specific file said portion denoting a network address for said first networked information source.

c) communicating with said first networked information source using said network address; and

d) retrieving contents of a data file at said network address, said data file containing said data, said data relating to information items stored at a second networked information source.

In a fifth aspect, the present invention provides a data processing device having data storage means, said data storage means having stored thereon computer readable code for executing a method for retrieving data from a networked information source, said method comprising the steps of:

accessing a specific file corresponding to said networked information source;

locating a portion of said specific file said portion, denoting a network address for said networked information source;

communicating with said networked information source using said network address; and

retrieving contents of a data file located at said network address, said data file containing said data, said data relating to information items stored at said networked information source.

In a sixth aspect the present invention provides computer readable media having stored thereon computer readable and computer executable code for executing a method for retrieving data from a first networked information source, said method comprising the steps of:

accessing a specific file corresponding to said first networked information source;

locating a portion of said specific file denoting a network address for said first networked information source;

communicating with said first networked information source using said network address; and

retrieving contents of a data file located at said network address, said data file containing said data, said data relating to information items stored at a second networked information source.

In a seventh aspect the present invention provides a communications signal for transporting a copy of a software application from a first computing device to a second computing device, said software application comprising:

a script engine module for interpreting said first data, said first data including a network location for said first one of said networked information sources;

a communications module for retrieving second data from said first one of said networked information sources, said second data relating to information items stored on a second one of said networked information sources;

a graphical user interface module for presenting at least a portion of said second data to a user,

wherein the or each script file corresponds to said second one of said networked information sources.

### DESCRIPTION OF THE DRAWINGS

A better understanding of the invention will be obtained by considering the detailed description below, with reference to the following drawings in which:

FIG. 1 is a block diagram of a system for distributing data according one aspect of the invention;

FIG. 2 is a detailed block diagram of the script engine module used in a portion of FIG. 1;

FIG. 3 is a block diagram of a screen shot illustrating the user interface used for the system in FIG. 1;

FIG. 4 is a second block diagram of the user interface of FIG. 3 illustrating the independent nature of the separate subsidiary sections;

FIG. 5 is a flowchart of the steps taken by the system of FIG. 1 when executing a method according to another aspect of the invention; and

FIG. 6 is a block diagram of a section of a computer network illustrating the data flows when the system in FIG. 1 is in operation or when the system in FIG. 1 is being distributed.

### DETAILED DESCRIPTION

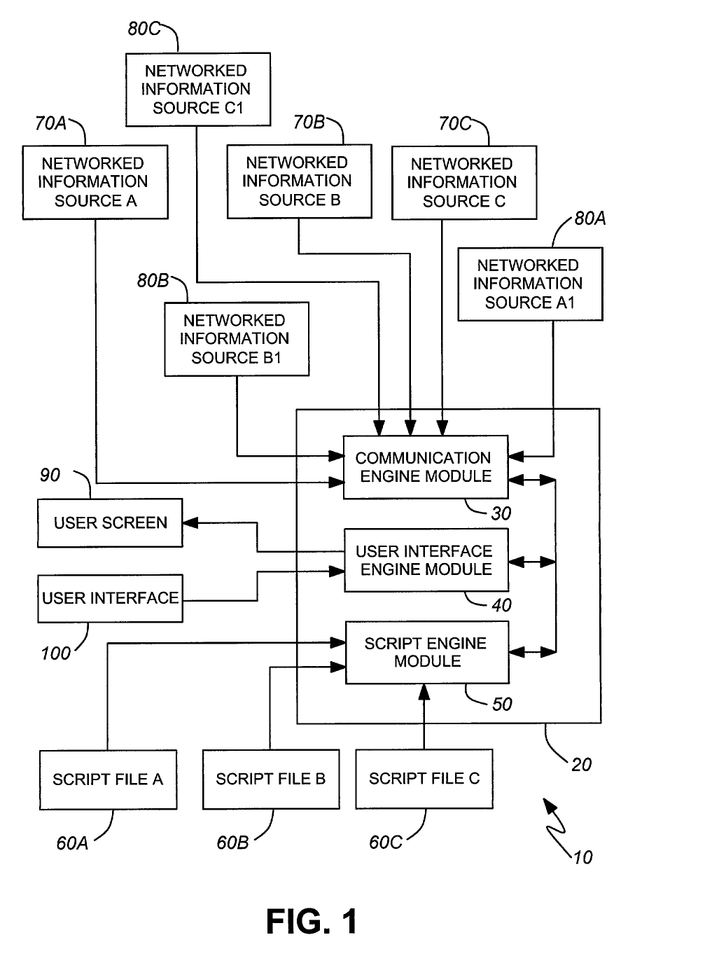

Referring to FIG. 1, a system 10 for information delivery to networked end users is illustrated. The system 10 includes a software application 20 with a communication engine module 30, a user interface module 40, and a script engine module 50. Communicating with the software application 20 are script files 60A, 60B, 60C, first networked information sources 70A, 70B, 70C and second networked information sources 80A, 80B, 80C. A user screen 90 and a user interface 100 communicate with the user interface engine module 40.

In terms of connections, each one of the modules in the software application communicate with each other. The script files 60A, 60B, 60C all communicate with the script engine module while all the networked information sources 70A, 70B, 70C, 80A, 80B, 80C communicate with the communication engine module. The user screen 90 receives its input from the user interface engine module. This same module receives any user input by way of the user interface 100.

Each one of the script files 60A, 60B, 60C corresponds to a single first networked information source while each one of the first networked information sources 70A, 70B, 70C, corresponds to a single second networked information source 80A, 80B, 80C.

In operation, the script engine module 80 reads a script file 60A, 60B, 60C and finds a network address in the script file for a first networked information source corresponding to the script file. As an example, if script file 60A corresponds to first networked information source 70A the network address for first networked information source 70A is in a specific field in script file 60A. Once the script engine module 80 retrieves the network address (first data) for a specific first networked information source 70A from the script file 60A, the communication engine module 30, using this network address, communicates with the specific first networked information source and retrieves second data from the first networked information source 70A. The communication engine module then retrieves data from the first networked information source 70A. This retrieved second data is then processed and either a portion of the second data or by a product of its processing (third data) is sent to the user interface module 40. The user interface module 40 presents this third data to an end user by way of the user screen 90. The end user, if he or she so wishes, can activate what is presented through the user interface 100. Since the second data retrieved from the first networked information source 70A relates to information items stored in the corresponding second networked information source 80A, user activation of the third data presented retrieves or activates this specific information item stored on the second networked information source. Activation or retrieval of this information item may activate other applications that facilitate viewing and/or activation of the information item.

Each of the script files 60A, 60B, 60C are independent of one another and the script engine module 50 accesses each script file separately. Similarly, any data retrieved from any one of the first networked information sources 70A, 70B, 70C, is presented to the end user independently of data retrieved from other information sources. As an example, data retrieved from first networked information source 70A relating to information items stored on its corresponding networked information source 80A is presented to the end user independently of data retrieved from first networked information source 70B.

Each script file/first networked information source combination is managed and accessed separately and independently of any other script file/first networked information source combination. In effect, each script file/first networked information source combination represents a separate and independent data channel to the end user. The script file provides the location of a first networked information source and second data from this source is retrieved and processed and then presented to the end user as third data. This third data allows the end user to activate/access information items stored on a corresponding second networked information source. While each script file contains a network address/location for a single first networked information source, each script network file ultimately corresponds to one of the second networked information sources. The first networked information sources provide an introduction or a link to the information item that the end user ultimately desires. As an example, the data retrieved from one of the first networked information sources may be headlines of news items stored on one of the second networked information sources. These headlines are presented to the end user who can, if desired, activate the headline presented. This activation causes the retrieval of the corresponding news item from the relevant second networked information source.

In one embodiment, the script file is a text file containing specific fields and specific field identifiers. The script engine module 50 parses the text file to search for the relevant field identifiers and for the data contained in those fields. The data is passed to the relevant module. The script file can contain any number of fields and those fields can be any combination of the following non-exhaustive list (broken down into sections):

A an identifier tag which identifies the script file as being for use with a specific information delivery application; and

an owner section that contains information pertaining to the owner/distributor of the script file.

B The owner section can have the following fields:

an author field that contains the name of the script files author;

a copyright notice field for the owner of the script file; and

an email address field for the email address of the script file creator/author;

a website field containing a URL (uniform resource locator) or Internet address for the author's/creator's home page or support page.

C An identity section which will contain fields that identify a script file as being unique. This section may contain the following fields:

a title field that names the script file;

a version number field that identifies the version number of the script file;

a “last modified date” field to indicate the last modification data of the script file;

a description field that contains a short description of the script file; and

a keywords field that contains keywords that a search engine can use to find relevant script files in a database of multiple script files.

D A locations section containing URL or network addresses on locations where files/data relevant to the script file can be found. This section may have the following fields:

a default link field containing an Internet webpage address for the script file owner's webpage. Activation of an icon in the user GUI (see below) will direct the end user to the webpage pointed to by the address contained in this field;

a content source field containing a URL or network address denoting the Internet/network address of the specific first networked information source corresponding to the script file. The field points to where data is to retrieved from for processing and presentation to the end user. Every time the data (third data) presented to the end user is refreshed, the address contained in this field is accessed;

an icon field containing a URL for an image to be used as an icon for the script file on the end user's GUI;

a banner field containing a URL for an image to be used as a banner for the script file on the end user's GUI;

a help field for a URL or Internet address for a help webpage for end users of the script file; and

a script file location field containing a URL or network address where a copy of the script file is located. This address can be used by the software application when determining if a newer version of the script file are available.

E A setup section containing fields which can be used for user configurable options. This section may contain:

a refresh field denoting, in minutes, a time interval between which the second data retrieved from the corresponding first networked information source is refreshed.

F A script field/section containing specific instructions for the software application on how to process the data in the fields of the script file and the second data retrieved from the specific corresponding first networked information source.

G A fingerprint field which contains a string of alphanumeric characters which can be used by the software application to authenticate the script file as being from its supposed author/creator or to determine if the script file has been tampered.

By way of example, the following template script file is presented. It should be noted that the following script file is protected by relevant copyright treaties and legislation. It should further be note that the terms Klip™, Klipfood™, Klipfolio™ are trademarks of Serence Inc. Klip™ refers to the script file while Klipfolio™ refers to the software application and Klipfood™ refers to the data retrieved by the software application from the corresponding first networked information source.

<!-- COPYRIGHT AND TRADEMARK NOTICE
The Klip File Format is copyright 2001, Serence Inc.
Klip and associated marks are trademarks of Serence Inc.
All rights reserved.
For details visit http://www.serence.com/p_copyright.html
-->
<klip>
<!--Please note that information in this Klip will be available to the public-
->

<owner>

<author>

<!--your name-->
Serence Inc.

</author>
<copyright>

<!--your copyright notice-->
Copyright 2001 Serence Inc.

</copyright>
<email>

<!--your email address-->
info@serence.com

</email>
<web>

<!--your web address-->
http://www.serence.com

</web>

</owner>
<identity>

<title>

<!--the title of this Klip-->
Serence Sample Klip

</title>
<version>

<!--this Klip's version number-->
1.2

</version>
<lastmodified>

<!--the date this Klip was last modified
yyyy.mm.dd:hhmm-->
2001.12.20:1208

</lastmodified>
<description>

<!--a short description of this Klip-->
This is a sample Klip provided by Serence.

</description>
<keywords>

<!--a space delimited list of keywords for matching your

klip during a search

the order of the keywords is relevant no more than 15

keywords will be processed-->

Sample Serence Klip News XML Engine RSS

</keywords>

</identity>
<locations>

<defaultlink>

<!--the url this Klip links to by default-->
http://www.serence.com/sample_site/index.html

</defaultlink>
<contentsource>

<!--the url for the KlipFood this Klip uses-->
http://www.serence.com/sample_site/sources/template.food

</contentsource>
<icon>

<!--the url for this Klip's default 16×16 gif or jpeg icon--

>
http://www.serence.com/sample_site/sources/sample_klip_icon.gif

</icon>
<banner>

<!--the url for this Klip's 234×60 gif or jpeg banner-->

http://www.serence.com/sample_site/sources/sample_klip_banner.gif

</banner>
<help>

<!--the url for this Klip's help web page-->

</help>
<kliplocation>

<!--the url where this Klip is stored
this is where KlipFolio periodically checks for updates to

your Klip-->

http://www.serence.com/sample_site/sources/template.klip

</kliplocation>

</locations>
<setup>

<refresh>

<!--how often, in minutes, this Klip should look for

new RSS data-->

120

</refresh>

</setup>
<script>

// the instructions for processing data
// details on how to modify this are coming soon
rssEngine = Engines.get (“RSS”);
rssEngine.process (Setup.get (“contentsource”));

</script>
<fingerprint>

//the authentication string goes here
//the implementation depends on the
//encryption/decryption engine used and the keys used

</fingerprint>

</klip>

As can be seen from the above, this specific implementation of a script file uses the RSS format for syndicating headlines. As is known, the RSS format is a simple and well established XML (Extensible Markup Language) format for syndicating headlines. While the above example would retrieve an RSS file and its data from a corresponding first networked information source, the RSS format provides each headline as a link to its originating news item. The second data retrieved from the corresponding first networked information will therefore consist of, for this particular implementation, the headlines in RSS format in a file located at the address contained in the content source field. These headlines are then processed to produce the human perceivable form of the data for presentation to the end user.

It should be clear that while the RSS format is used for the example, other formats can be used and second data other than headlines can be contained in the corresponding first networked information source. Another implementation would have an end user's electronic mail mailbox network address in the content source field with specific script commands in the script field/section for retrieving the header information of unread email in the end user's inbox. Such header information, such as the email subject line and the sender's name, can then be presented to the end user in a fashion similar to that of the headlines.

Similarly, the content source field can contain the Internet address of a specific website that has regularly changing content. The script field/section can, for this instance, contain script commands that instruct the software application to parse the text of the website and extract the headings. These headings are then downloaded and presented to the user. Yet another implementation would have the network address of a network/system/device monitor. The script field/section would contain script instructions to access the website and check a specific flag on the website. If the status flag changes, then the end user is alerted by way of the GUI. Activating the contents of the GUI then directs the end user to a website (a second networked information source) through which the end user can either find more information on the event(s) that caused the flag change or access a control panel through which the end user can try to remedy the situation.

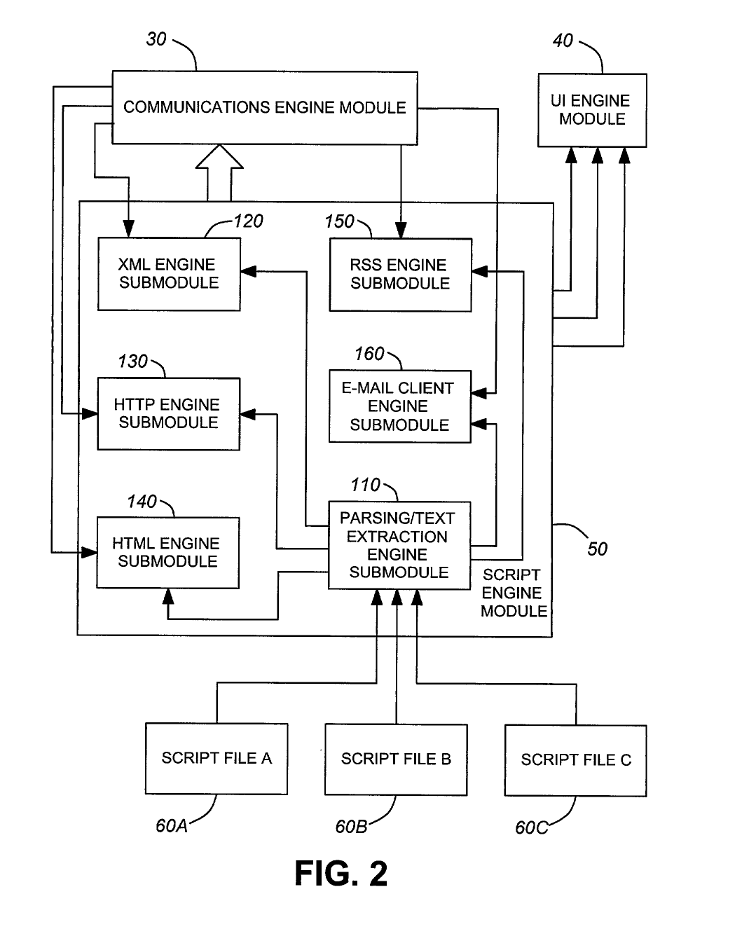

From the above, it should be clear that the script engine module 50 will have more capability than first being able to do simple parsing and test extraction. The script engine module 50 can send instructions to the UI Engine module 40 and the communications engine module 30. Referring to FIG. 2, a block diagram of the script engine module 30. Referring to FIG. 2, a block diagram of the script engine module 50 is illustrated.

As can be seen, multiple submodules in the script engine module extend its capabilities. A parsing/text extraction submodule 110, an XML engine submodule 120, an HTTP engine submodule 140, an RSS engine submodule 150, and an email client engine submodule 160 populate the script engine module 50. The parsing/text extraction engine submodule 110 receives data from the various script files. The parsing/text extracting submodule 110 then parses the text from the script files and extracts the relevant network addresses, script instructions and other data from the script files. Based on the extracted instructions, other submodules are then activated. If the extracted instructions call for an HTML document (the second data) to be downloaded and presented to the end user, the HTML engine submodule receives the HTML document from the communications engine module. The HTML engine submodule 140 then processes the HTML document to arrive at third data for presentation to the end user using the systems' GUI. After such processing, including possibly formatting, extracting text, stripping extraneous, or extracting images/multimedia content, the presentable end result (third data) is sent by the script engine module 50 to the UI (user interface) engine module 40. A similar process is followed if the script instructions from a script file calls for the content/data to be retrieved in XML, HTTP or RSS format. The content/data (second data) retrieved is received by the relevant submodule and is processed or interpreted by the submodule prior to being sent to the Ul engine module 40 for presentation to the end users as third data. For email messages, the email client submodule 160 receives the headers of the unread emails from the communications engine module 30 as second data and extracts the subject, sender and time/date sent. It is this third data that is sent to the UI engine module 40. It should be clear that the script engine module 50 sends instructions to the communications engine module 30 to enable the communications engine module 30 to retrieve second data from a first networked information source. Depending on the type/format of the data to be retrieved, a submodule can send specific instructions to the communications engine module on how the specific first networked information source is to be contacted. As an example, if the script file calls for retrieving the headers and subject lines of unread emails for a specific user on all email servers, the email client engine submodule 160 needs to send to the communications engine module 30 not only the network address of the email server but also the relevant user ID and password to allow the communications engine module to login to the email server. Also, the submodule may also send to the communications engine module 30 any specific protocols/formats needed to retrieve the data. Thus, the email client engine submodule 60 will need to inform the communications engine module 30 as to the type of email server to be contacted and whether any special procedures are to be used. This is due to the differing email handling procedures that POP, Microsoft Exchange, Eudora and other email servers use. To ensure the proper retrieval of email, it is advantageous for the email client engine module 160 to specify to the communications engine module 30 the type of protocol/format to use. Similar to the email client engine submodule 160, the other submodules can send specific login/handling instructions to the communications engine module 30.

While the diagram in FIG. 2 only illustrates six types of submodules, other engine submodules which can extend the capabilities of the script engine module 50, and, by extension, the software application 20 can be added.

As an option, script files can be authenticated by the software application using the fingerprint field. The authentication can be executed by a dedicated encryption/decryption engine submodule in the script engine module. Using the RSA encryption/decryption system and using the contents of the script file along with the contents of the fingerprint field the software application should be able to check if the script file has been altered in any way. The method, as described in U.S. Pat. No. 4,405,829, incorporated herein by reference, works by using three pieces of data along with a clear text message to be encrypted. A module n, a public key x_{pub}, and a private key xₚᵣᵢᵥ is used to encrypt and decrypt a message m. The message is first converted into a numerical representation—a process easily accomplished as text can be converted into binary or hexadecimal equivalents. Then, to encrypt the message into an encoded ciphertext C, the following formula is used:

m^{xpub}mod n=c (1)

to decrypt C, the reverse formula is used as follows:

C^{xpriv}mod n=m (2)

To authenticate the script file, the modulus n is inserted as the contents of the fingerprint field. A trivial number, such as binary 101, is used in Equation 1 to arrive at a value C using the text to the script files as the message m. The number C can then be reduced to a smaller representation which can be inserted into the script file as well. To determine if the script field has been tampered, the software application merely applies Equation 1 as outlined above using the modulus n and then compares the resulting C or its representation with the value inside the script file. If there is a discrepancy between the resulting C and the value in the script files, or if the modules n is not present in the file, a security violation may have occurred and the end user must be altered. By submitting authored script files to the software application providers, script files to the software application providers, script file authors can be provided with an amount of certainty that their script files are secure in that tampered script files will be detected. Clearly, the software application providers will need to insert the modules n and a value C or its representation in the authored script file prior to its distribution.

The above security model can be further extended to constrain the end users who can access specific data retrieved from a first networked information source by the software application. Selected users are provided with the relevant script file and the script file will only work if the computing device on which the software application is installed matches certain parameters. As an example, the script section of the script file can contain instructions to determine if the computing device running the script file is registered to end users A, B, C, and D. The names of these end users can be encrypted inside the script files to prevent other from discovering their identities. Or alternatively, only the value of the resulting encrypted message (the end user name) is inserted into the script file. Extending the example, if end user A has a name which, when encrypted using the above method with a specific modulus n and a trivial x_{pub}, results in an encrypted value C_{A}, this value or its representation can be stored in the script file. When the software application needs to retrieve the content for presentation to this end user for this particular script file, the software application checks the registration data (such as by querying the operating system) for the registered end user name. The registered end user name is then encrypted and the resulting C is compared with the CA or tis representation in the script file. If there is not match, the data cannot be retrieved from the specific first networked information source. If there is a match, then the data can be retrieved.

A further security precaution further extends the security model outlined above. Whole sections of the script file can be encrypted when then script file is distributed and installed. The script engine module, to pause and retrieve the data in the script file, will need to decrypt the script file. This can e done by encrypting the whole script file except for the fingerprint filed. The script engine module will then retrieve the modules as contained in the fingerprint field and, using a trivial, predetermined xₚᵣᵢᵥ, decrypt the script file using Equation 2 above. Once decrypted, the relevant data can be found in the script file. The decrypted version of the script file is never saved on the computing device and the end user has no access to the data in the script file except through the software application.

For the security model explained above, the following numbers in hexadecimal form can be used as the modulus n. This list is not presented as being an exhaustive list but is merely provided for illustration by way of example. The numbers are:

Number 1:

b32b5b13ec6baefabf71d6654f45f29f3f54d13abd931c2e9552009ee2dcc23f98251f21712035 6bd1fee5b94ffc0dd5842f361887927 db5e4d599f5c026f6f29b26bedeaca7b592334859e2059de0d4bc54f79bf389b861ba85bd45b9b0be89ca5892181e2e842f7ba78e61f62ab0f4f58937940 6df47d1b11eaa2d90426d3

Number 2:

c8dea169cd564b3 dbf73fc2656712ce3503aaeea0dfd8fc6869eee7369449e288b40450496e69 4ca148cfb559b87ef2465d783c9d6d339f015695f582907761b10d55d38b3992fc6c95beb690f2 5e4f5015bb21d75bca3f1b9446899e1dfd0fa2c2173e8c6e3ebd71352af6d71b8c462cbf86e02f6edd8c9d546eea96269c9

Number 3:

b2a4a7bffdea47c0318aef35dad8d3202dd934f67c6 cc25720b88ce978d62682e4187f0bb0d4f6 8b9004def865573c3752d153f1ca189eab34bb3bedd8592917ffc7d51adfa2eb6a5ee581720e3f 412e92b8310c25681e59a860d335458fac23bcdb4f9c049b06534efee2fe48c36f323396 db7726 5009924a979f839317479b

Number 4:

9c721bd382d73acf747197b590886f724856d1126a9d83b73fc093b390ddaed4469132ca238181a2631fc785c92a2461a270738446067b5f35e3586bb6eafd919fe0d825fd1e0f204a30356e9ed8 7d26a2338 db635a266b21df23aa4ffe0994ac2ff30748fd28049339eff1caaafea6d999cb8a019a0aaebe9902baa549e72b5

Number 5:

932edc5c8d17f26c045c8c042940068c1c7f7c9f6 cce160f468b50ce8c6bbb84c64b607c2b199f c151b3b7170158e985fc87deea46a443cab24e6be90aec343d9a28c1ce26af647ea84ffdcaf34b d46771965f4cae011c5734f3a7bdb5f7ec7a69f3c02645b938578ffb1dfed352f41573659e3d41 57e8602da0f94768d03189

Number 6:

c87541fa586b09864534ef4677e069e8208538f0578aa5689008d38932abae31def20a9336fddf 3a426fa7c08b3e1e15be4f6a6f16678b69ff6df725de0744c5e02c3cfb2a63adb99 dbc1a2a558b dd4a45f7f4b606b1c83f99d9ad65454ca21ac77bde29c89903e5f6a7c7e04307f6743c5a2555b7c3d27642758bafe87a2dad

Number 7:

b119fc0959e7c1bb55337e5867c69f316290fc8300408cd0a68088a2e81ee038005b39225377b2a1de22428ab0d5b36be761741d51fb57fe8d55c2566d7e7ef3f3da5301a333a83280ec57b80c5e 13b95985b4bb75f97f434fb3f50e10bb3eb5d013182a75b6f8a96de37d862e0742bc59a5512696a8dca2592856 db38 cc6adf

Number 8:

b2ff078d08c01a4ec0c5ce14faa9d340d5e66c2b05cb4876070c75741923f374b2fa5ea6f6fa30 0c22f841f15250cf0e85de606a0a33eb0b095d63d09068f70dafb3602930ef1bbd983525592bbb cdfe5bdada1d1e135585a2d09c2ae105f0f28980b646ae25a8e60b476e8fa906c915c4024734a4 9cbc165845e5c95fa49c85

Number 9:

a4dd6c5ef7fbdfdb4cb7d0d5175b37849df855bdc56eef307271cfc4042744c25099d67e31fa97 5eb3edffb3154ecf52dfa4287632a0ff21781e367a66a30663ff2f3c90f73c811112df34d52d47 6f3723f4cc0874208c91e9003f0558b9d6c5c836e0c26d499d409c49ebb2ded21739b90148eb9f 85f5715f3b0204ebfa635d

Number 10:

c78e63d3de59c3ef33e3adb6916ee28c56a874d4d2330a85aed09f71289bb4468f15a2c669be8c 2f36ebfaf822793402ad2b01771d2ba91f4e9b8e1ce47e07c5f36aa5f3e5d5ca6fbb9b4ff6e5be d1cebb48fdba912d28b4be04cafa2 cc7fd3f8adea5511e590e3105a05fd8cbad8a0d5ef9960393 1e83e07f3f2944e82f0223

Number 11:

b7317af7b36d92e9df09aedf8aa4467b566075bddabe060ba96df705d61096d41cbfbf0d500fae a17f151dbe4dc395d0df8e48596324af6a7aff6e9fbc976586bb49043d6cd374b27631c64cf611c42ad63662719cdcc3c8a5129f796470c96e6bd0241aa91adbe0e2e1930bf17a45a1ded45f0172 728c0ba76d0461d6c4014b

Number 12:

e654ceb9f61cbe17da4fce548551d4 db641169d58bcbc5af62f91b2c581a71c3a0c93612f098 cc 8561197d2f87a01eeddefd92f063be64e5a5d0a07d84c097c57a02b16b899908ef837fc19741ff 2be91ca27cbbc0eba11c3c2a10cd30bda7e1aaaf3d09a0fb84ff92676a4722271561ef74b4d3f1 978a291dec943b51741e49

Number 13:

b9605 cc8071b0598bf639e9a95cab53ae0cb2fba22217b110c551dea3a5909a51b353670cd812d d4228656acff86b043765f9d8d8675bd7b2717 cc0c750e6bfcdcbc19be98c42bb430a9a985da19 838ca151947bb74872087677cb22439cee98002660e240e20868f6ed483d6d76f375483df0d1cf 4a9cf99834c58c52fc287b

Number 14:

a0772decbddf64f8bd52c3756895b66d211a28732a7ed37ea6e26793b3bcbb4c304c62ec373568 24a6554c2377fa14456a6b2e05de009588bf1d916e226557caeb719e1ccb885c5bcd9e64147ba 36aa8165c40fffcf37e25ec8aed68d46b37bbba6f7878f331d6cf01fdad894146f153b02576a6d668059 db3524c65a5f69d

Number 15:

a562a32df57d8020b62445ec71edbc302df8b9eb25d2bb5022811ea6c6b02020c3af6dd57c98d3e1672156e0322248c32d04bf506a599a14fd2f7177b84717ba1fe35c84aab276b8cb43df7f9aac 8605d687b4653732315742c776f4a982d0a4c41bf7a6c7a3ae29bfadc408ce4b2d493b97fe9220ff5c40108912c1c5e687a7

Number 16:

d58250a8136b0a79a1ef8336e095f80fab870eea27eb48 cc32534015a4c5e5397a178f4028290c 7704d82ee33a11821576ad36564b05e517252a56985fc1329687c184e5175bccf39bf9288169a6f43c3d8bfcdc461097f3096120f5318b7acae596598f0a9166a444af6ca6f59bf7b01a05c1eb75 1bd93ec3b8da3f6845d741

Number 17:

dd97e47a29c6b63a7 cc1e81121fe06f0f7705a1843672d2ef05b693fbfc9cfd97c06b9773 cc604a0dfd5b3b38c65908407c736466e6bf16e22188ae1c8ff536fc74d36693506f53be8d465c746ec 96c877ca8ca9d54b42ca90c380dda83459e95c92aa2205e820d28f981207292 cc0a0f6eade5b86e3d2c31bcd7f072f95460b

Number 18:

a44127d0d7d16a8d4c9ea254296d425c8009f015a84393dfe22ece621faa92c70c475319ddec78aee1ed72c664f630427845bd775d3e2c951eb65993ac2ac1ec71ca9ef2d47158458be2e84eeba2 2e178a60ef902a88aff6e18b62 cc744087bd6179109f932f7cf25e1c21f4f946852544cacb877e f064e4e04 cc15b51ee074b

Number 19:

dd438ac8b7fbd9689794946656d8b40c35a28f76c097338fa19c782a0255f50e9d5a5ecc474bb7 47d5a02699050e1f257daf2ae4f846bf6ee5415f365289bfc250ae968c44df8b2294a3daf2b2c8 109546a169c4f67f0c49a91602b4a2223fde6e24aa8b77b55072e78a9ea995b343846a25719f4a 9603fad300b12a465743c1

Number 20:

9f3c316e113c8a714013e5932786f1d749ba1776bad9a59c19f61a6be834754a1fb54e6158a817bb04837a6397831d7b454342bdc6952533e97b49c7961e0b608bdc0c41ab6fc28d50de0f2969e9e9b98c7d807756a1b9a6f41d083ed625b3177858723dfd83e5f0fd33b5a798cd806c8295351c76 449937924541e890385deb

Number 21:

be91216d523c7d82a86e4b2e31e96c078ec4a4d5bd162c9dc9ddf6fe6de8cadac13c9b2ada453b 0b016c98915a065e19cb24e6cd10ef262b4d96a62a14 db52dcb2f7de32f898e77da8b83e74fc4f c1cb1cb1f58dcfbfa0f2449d57f89b982423484014287490587c92cf22771e7a1c3447d1bb5456a49f4246a9df5d6d4fb12b

Number 22:

f1a28f3ad1e91bf83929f2 cca8faa60050e7d953e44be08e5c8806ad3e3a1a405da4cdee53e64f 6ce1189d77066e2152ce4f286c2058455073109682806a691e41d10e3166224efb4feb5b2ae3e2 4c8 db17f82574c7598defe07132581f8888d95ca72fb499e1ae3d53e4fe34ba41dc16a6898b653 4b7ba71fd36049a580b7c1

Number 23:

cb3a2367585ddf746e86f8f88f6eaac5cdf9baeab4d8aa16d25fd6239d95c6089c84d3bef80854dacdeeb2152d8eda8c78bfb55ea9e923bfefacca9d71dbb9f18f6f28af6a7a40d343056c67947a fdb69cd5354a155dafca48051194a184a3761430229d1022d9397839fbe6 db5781f372a4f8244a 3f3a334c45c7510238f33b

Number 24:

b4d0d35299d4a03a4dfaf77fb8d102fa17064521b0d985fd28419dddd8878c134b73e2a86fab13b56155322ffcc7f70c4dae3b9ae74aa1b1e71d6b79ed6dd3f27d87d32fec9d7e03be66ee56af7b 692a963a9cb6557b548feedc6c0f33a4be476185ff4ee6d8e5cdca813d0de5870a38b5b45450df 0cd9cefb90c1d9125 dbfa7

Number 25:

c2c58733f9aa7f3bda33f9a798311f94 dbe1d0ed0c8190ac248b1e527c29b3bb8d262a83f54d5e 82ca21524634311a740a1b31e26f37bac08816d3992c2006c06726cb80206ad04be3b09fd150d 08305b587a06c7 cc5f1232f879f930fe30d95063a1134cf1ba064f959af64d0878fb42a43f97ae b18d4ede6a2adc9df2c305

Number 26:

d4a8cb2ff79569d82389a6250f9c59de0f3992ac94dcc8ea41cefedf54ea45 cc4e411774571dbe 38e78aa70f7523d8e1d3025b2d84040 db9396d1fc27b9e8067217d29f394aa225d534d7c8c664e 8e83059127cec8390cdb3867cd185da8bf45457695728e63df0c14e0cb2921aa552b33b174583d 0461dd7967b75bcdf5c7b3

Number 27:

a043b88b07205b8d4835345 ccbb18e533 cccd4778b89016040288c60d06ddf1d7ed79933cab68c c1bd118fe8863ec8cbbf2f0ff019bc7c3f3543794ef889b4b3be118b835727537de9040b4175d0 79e73acef5ea475d158a2b18860ce5ab8d2ad8cf2b21ec1894d9ea5d2adc0fe3f49906fef48ae9 3f9c1d9c83a6704e18d5a7

Number 28:

bef3c5dac4be24ed7e4f9dddb977ebc6441738004a547939b5b689de7c50f98b93994e905bcbc ef896ac583895115f5891bbedd9d20c4d0bc1c656b3ec2c9379636d0a3420e333161860de3b57d 5677fbf415031098d7de8f1259e637e4ba31105b92c94bdaed82753b06b780cfe2fbec9e2034a 3018b8351bd2e2f1c614e7

Number 29:

baacd9fc6c4eaeaddc08383ab43de502fa0dd822f5fd6b958d966b8a8d2e1c2b304fe6a9c1640d d325e2372fdbebd9125f6c179a2aee91ab4f527acc6241691a15999d4de50df792203c3e7048f5a26729ab56cde31a050de313a7fe7b343586ac9147c1116ba17828331e930d13c218155f00703b f1c16f5e4170e2b81f59d9

Number 30:

b776876773cabe517edf254f8a1fd015dea55d1e1e1e2597abf583639b541a0fc85bbd6be5563 09fc4d486c12ddf63f24a34366a85e14eb30b6af3e52200d0e755b03fee2360446507b0ebce021e443b13e1411af11466dadc994e1733fc0dd24347e097d1bab5b938b67de888f78a1cd63d34e45a68816b4aa8a566a12aaad

Number 31:

d59664b6fad8a1c046711ea001124c8ca2d771a7f640ce32cb65238a92d199f3ab005863c97d 25d7794560a52546e13bb7b3d7696d63a4575ca0db90596c885b1a13f384710c6d5170af7b4d 73959a2116df24c8e4daf45bdcd62c4ff3d97b755bf022dd2b62025ee086e9942fa000761678 9b5e0e0c39398526a96794640929

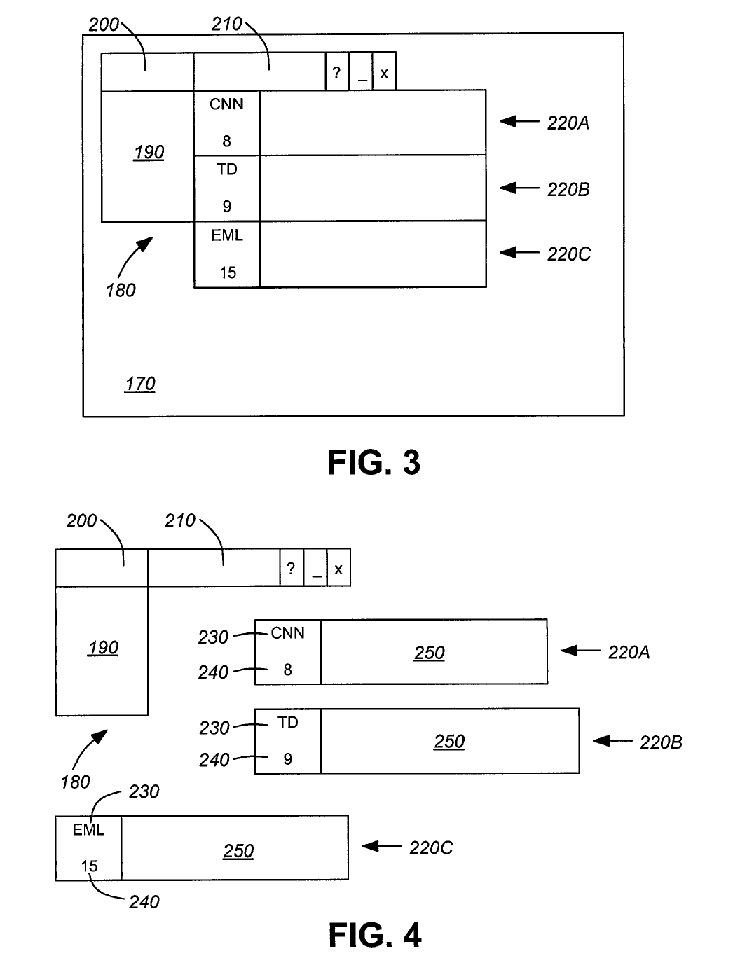

The user interface to be used with the software application is illustrated in FIGS. 3 and 4. As can be seen, the graphical user interface occupies only a small section of the user screen 170. The user interface (UI) has 2 parts: a main section 180 with subsections 190, 200, 210 and a number of subsidiary sections 220A, 220B, 220C. The main section 180 has a subsection 190 for use by the software application for system alerts and status alerts. Specific icons can be present in this subsection to indicate specific actions currently being executed. As an example, an animated icon of arrows revolving in a circular pattern can indicate that data from a first networked information source is being retrieved. Another subsection 200 can contain an icon which, when activated by the end user, such as by checking will launch a preferences or set up menu for the software application. This subsection 200 can contain an icon which, when activated by the end user, such as by checking will launch a preferences or set up menu for the software application. This subsection 200 will provide the end user with ready access to the software applications settings. The third subsection 210 will provide the regular task bar icons for help menus and for minimizing and/or closing the software application. In FIGS. 3 and 4, this subsection 210 is provided with the standard menu items used in the various flavours of the Windows™ operating system from Microsoft Corporation.

Each of the subsidiary sections 220A, 220B, 220C, corresponds to a separate script file and, consequently, to a separate first networked information source. These subsidiary sections, while shown as being locked and integrated to the main section 180 in FIG. 3, subsidiary section, as illustrated in FIG. 4, has 3 indicia present, a first indicia 230, a second indicia 240, and a third indicia 230 is an icon indicative of the first networked information source corresponding to the script file to which the specific subsidiary section corresponds. The icon for this first indicia, for this implementation, can be found using the contents of the icon field in the locations section of the script file. This icon can be a recognizable corporate logo, such a CNN's stylized acronym, or a stylized symbol such as an envelope denoting email.

The second indicia 240, in one implementation, is a number indicating the number of information items in the second networked information source that has not been activated by the end user. As can example, if the first networked information source was a news network and there were fifteen new items, the headlines of which constitute the data stored in the first network information source, the number 15 would be the second indicia if the end user has not read any of these items. If the end user has accessed three of the fifteen news items, then the section indicia would be the number 12. Similarly, if 8 emails have not been read, the subsidiary section for the email associated script file would display the numeral 8 as its second indicia. The second indicia can be easily implemented by first determining the number of discrete data times in the data downloaded from the first networked information source. Then, for every one of these data items activated by the end user (as will be explained below), this number of discrete data items is decremented and displayed.

The third indicia 250 consists of text or representation directly related to the information items stored in the second networked information item. If the information items are primarily text based, the third indicia 250 can take the form of summaries of these information items. As can example, if the information items are news stories or articles, the third indica can be the headlines or the titles of these items. Similarly, if the information items are unread emails at an email server, the third indicia can be the subject lines and sender names of these emails. If the information items are not text based, such as multimedia clips or specific alarm type events, icons, thumbnail pictures, or other representations which can be activated by the end user can be used. It should be noted that if there are more representations than can be displayed in the subsidiary section, these representations can be scrolled through the subsidiary section, thereby giving the end user a chance to view all of the representations. It should further be clear that each of the representations can be activated by the end user and their activation either launches another application to access the specific information item or causes the software application itself to access the information item. If the information item is text based, or is an Internet document such as a webpage, a browser application will be launched and the information item downloaded for viewing. Similarly, if the information item is a multimedia file, a suitable viewer will be launched so that the file can be viewed. This aspect can be implemented by embedding in the data downloaded from the first networked information not only the network address of each information item referenced by the data but also its type. When the end user activates a specific one of the third indicia, the application/viewer associated with the information type is launched while the information item is downloaded.

While the above discussion refers to a graphical user interface, other non-graphical user interfaces may be used. A telephone keypad interface, in conjunction with a telephone handset through which the user listens to a spoken or synthesized version of the processed third data, may be used. Similarly, other interfaces which allow the end user to perceive, either by sight or by some other sensory capacity, the processed third data may be used. It would be advantageous if the interface used allowed the user to activate at least one of the third data presented by the system.

The number of uses of the above system are legion. For text based information items, news stories, articles, advertising specials, financial and investment reports (with appropriate encryption and security measures), email, and instant message are but some of the possibilities. Multimedia items such a streaming media, video or audio clips, and others can be used as information items.

By way of non-exhaustive examples, the information items may be any of the following:

data related to email messages;

network messaging content;

online messaging content;

online tracking indicating which members of a specific group of people are online;

weather reports;

stock and/or investment data;

price indicators for user selected items from specific websites;

current bid prices for selected items at specified online auctions;

software updates for specific software packages;

software additions for specific software packages;

news items;

data relating to most recent changes at user specified websites;

data relating to process for travel and/or vacations;

sports news items;

data related to a specific user's horoscope/astrology;

data related to problems with specific software packages;

data related to voice telephony;

data related to a specific user's calendar;

data related to a specific user's customized list;

data related to a specific user's voice mail;

data related to entertainment content specifically selected by a specific user;

data related to advertising by specific business entities;

data related to a video camera monitoring a specific area; and

data related to a specific online message board.

The content of these information items can be any digitized content including but not limited to textual, graphic, audio, video and computer executable content.

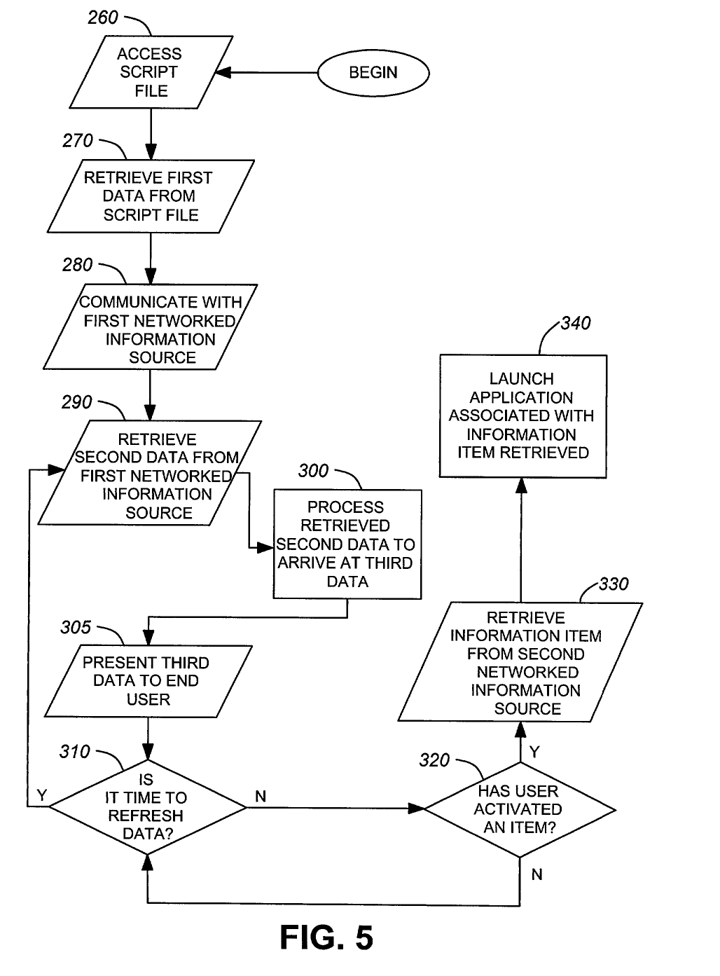

The process executed by the software application is summarized in the flowchart of FIG. 5. The process begins with a script file being accessed by the software application in step 260. After accessing the script file, the first data contained in the script file is retrieved (step 270). This first data, as explained above, includes network addresses of a first networked information source associated with the script file and of other items such as icons, required by the software application. After this data has been retrieved, this first networked information source is contacted (step 280) and second data relating to information items stored in a second networked information source is retrieved (step 290). The retrieved second data is then processed (step 300) to arrive at the third data. This third data is presented to the end user using the user interface explained above (step 305). Step 310 the checks if the second data from the first networked information source needs to be refreshed. If so, then the loop consisting of steps 290-310 are repeated. If not, then the software application checks for user activation of any of the third data presented (step 320). If none of the third data has been activated, then the logic flow returns to step 310 to check for a refresh. Otherwise, if the user has activated one of the items presented, then the information item associated with the activated item is retrieved from the relevant second networked information source (step 330). An application associated with this retrieved information item is then launched so that the information item can be viewed (step 340).

The software application outlined above and the system it is a part of can be implemented using any of generally accepted computer languages. The system can be installed and run on any computing device or data processing device that is capable of connecting or being in contact with a network. The network can be as large as the Internet or as small as a small local area network. The software used for the system can be stored in any magnetic, optical, electronic, or electromechanical means for storing object code, source code or software of any kine. The software application, prior to installation, may be downloaded fro websites, software archives, or from any type of software repository. While the above description refers to a networked environment, the end user who utilizes the invention need not be continuously connected to a network. The end user and the computing device/data processing device which implements or runs the system may periodically connect to a network to gather new content such as may be needed when the content requires refreshing. It should also be noted that the information sources need not be continuously connected to a network either. While it is ideal that the information sources be connected to a network, such information sources need only be able to send/upload content to the end user device/system running the application for the invention to work. Such information sources may therefore periodically upload new content directly to a network or to the end user. Alternatively, such information sources may be available when needed such as when an end user device queries/requests new content.

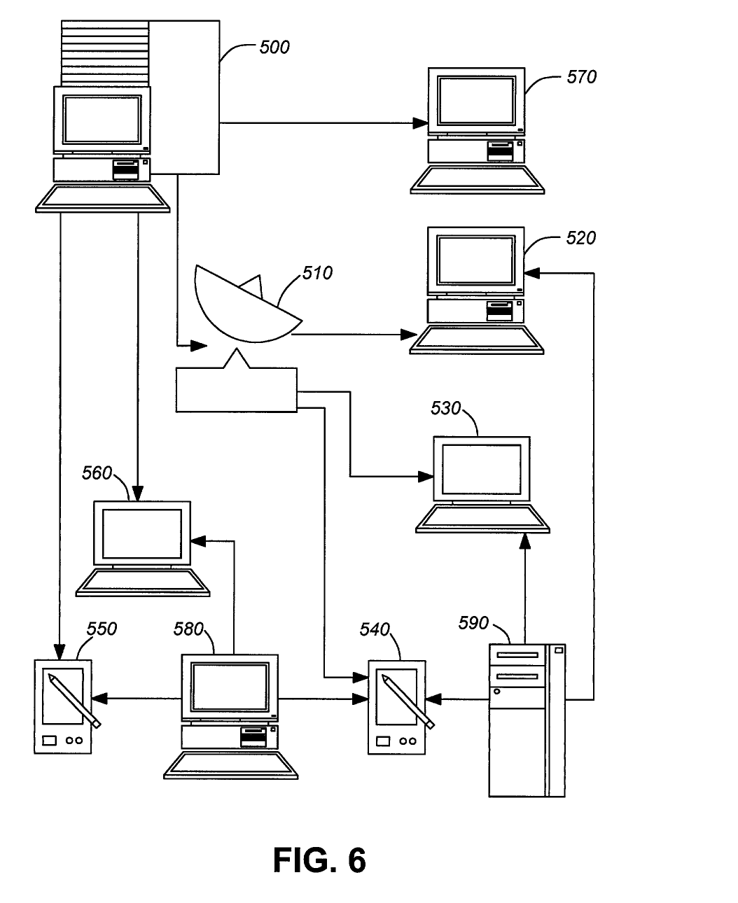

Referring to FIG. 6, a block diagram of the data flow when the system is in use is illustrated. As can be seen, a computer server 500 communicates directly to a PDA 550, a desktop computer 570, and a notebook computer 560. Indirectly, using perhaps a satellite or wireless connection 510, the server 500 also communicates with another desktop computer 520, a second PDA 540, and a second notebook computer 530. Any one of the computing devices (PDA 550, 540, desktop computer 570, 520, notebook computer 560, 530) can be receiving data from the computer server 500. The computer server 500, in this case, can act as a first networked information source—an aggregator of Internet content. Thus, the computing devices receive their headlines, their article summaries, and other data from the computer server 500. Should the user of the computing devices wish more information on or an expansion of the data downloaded from the server 500, second networked information sources (in this case networked desktop computer 580 and server 590) can provide the requested information items. As can be seen, the server 590 communicates with notebook computer 530, PDA 540, and desktop computer 520 while networked desktop computer 580 sends data to both PDAs 540, 550 and to the notebook computer 560.

The system may be deployed on any computing device that has access to a network. This access need not be continuous and the network may be wireless, optical, or wired. Thus, the devices which may implement the system are presented in the following non-exhaustive list:

desktop computers;

Internet appliances;

handheld computing devices;

Personal Digital Assistants (PDA);

cellular telephones (mobile telephones);

set top boxes for televisions; and

automotive based computing devices.

As noted above, the software application can be stored in any computer readable media. The object code for this system can be stored in a computer server such as server 500 and can be distributed to other computing devices, such as PDAs 550, notebook computer 530, and desktop computer 520, by known means such as encoding the software application in a communications signal which is then transmitted to the different computing devices. Such a communications signal can be used on wireless systems (such as by satellite as illustrated in FIG. 6) or in a direct connection between a server and a client such as the computer server 500 and desktop 570 or PDA 550. Ideally, the computing device to which the system is installed or downloaded to should be capable of connecting, either directly or indirectly, to a network so that data can be gathered from a remote first or second networked information source.

Embodiments of the invention may be implemented in any conventional computer programming language. For example, preferred embodiments may be implemented in a procedural programming language (e.g. “C”) or an object oriented language (e.g. “C++”). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

A person understanding this invention may now conceive of alternative structures and embodiments or variations of the above all of which are intended to fall within the scope of the invention as defined in the claims that follow.

What is claimed is:

1. A system for retrieving information from a variety of information sources in a network and for use with at least one script file, the or each script file containing first data corresponding to a first one of said information sources, the system comprising:
a script engine module for interpreting said first data, said first data including location data for said first one of said information sources;
a communications module for retrieving second data from said first one of said information sources, said second data relating to information items stored on a second one of said information sources and said second data being processed to produce third data;
a user interface module for presenting said third data to a user, wherein the or each script file corresponds to said second one of said networked information sources.

2. A system according to claim 1 wherein said information sources are networked information sources.

3. A system according to claim 1 wherein said user interface module is a graphical user interface module for graphically presenting said third data to the user.

4. A system according to claim 1 wherein said first data includes refresh data indicating how often said communications module retrieves said second data.

5. A system according to claim 1 wherein said second data includes text relating to said information items.

6. A system according to claim 1 wherein said information items are chosen from a group consisting of:
news items;
email messages;
data related to email messages;
network messaging content;
online messaging content;
online tracking indicating which members of a specific group of people are online;
weather reports;
stock and/or investment data;
price indicators for user selected items from specific websites;
current bid prices for selected items at specified online auctions;
software updates for specific software packages;
software additions for specific software packages;
news items;
data relating to most recent changes at user specified websites;
data relating to process for travel and/or vacations;
sports news items;
data related to a specific user's horoscope/astrology;
data related to problems with specific software packages;
data related to voice telephony;
data related to a specific user's calendar;
data related to a specific user's customized list;
data related to a specific user's voice mail;
data related to entertainment content specifically selected by a specific user;
data related to advertising by specific business entities;
data related to a video camera monitoring a specific area; and
data related to a specific online message board.

7. A system according to claim 3 wherein said graphical user interface module presents a graphical user interface to the user for displaying third data, said graphical user interface comprising:
a main section occupying a first portion of a user screen
at least one subsidiary section, the or each subsidiary section occupying a portion of the user screen separate and independent from each other section, the or each subsidiary section corresponding to one of said networked information sources
wherein
the or each subsidiary section contains at least one first indicia relating to a specific information item stored on a networked information source corresponding to said subsidiary section.

8. A system according to claim 7 wherein the or each subsidiary section has a second indicia to identify a networked information source corresponding to said subsidiary section.

9. A system according to claim 7 wherein the or each subsidiary section has a third indicia to indicate an amount of information items on said networked information source corresponding to said subsidiary section that has not been accessed by a user.

10. A system according to claim 7 wherein the or each first indicia can be activated by a user.

11. A system according to claim 10 wherein user activation of said at least one first indicia causes retrieval of an information item corresponding to said at least one indicia.

12. A system according to claim 2 wherein the or each script file comprises:
a source field containing said location data, said location data relating to a network location for said first one of said networked information sources;
a script field containing instructions for said script engine on how said second data is to be processed to produce said third data.

13. A system according to claim 12 wherein the or each script file includes:
an icon field identifying a location in a network containing said networked information sources, said location containing an iconic representation of an identity of said second one of said networked information sources.

14. A system according to claim 13 the or each script file including:
a link field identifying a default location for the said iconic representation which is accessed when a user activates said iconic representation after said iconic representation is presented to said user.

15. A system according to claim 12 wherein the or each file includes a storage field identifying a location in said network which can be periodically queried by said application to determine if newer versions of said file are available.

16. A system according to claim 1 wherein said script engine module processes said second data to produce said third data.

17. A system according to claim 16 wherein said script engine module includes at least one submodule for processing data, the or each submodule being selected from a group consisting of:
an XML engine submodule for processing XML data;
an HTTP engine submodule for processing HTTP data;
an HTML engine submodule for processing HTML data;
an RSS engine submodule for processing RSS data;
an email submodule for processing email related data;
a parsing engine submodule for extracting data from a script file; and
a data processing submodule for processing digital data into a human perceivable format.

18. A system according to claim 17 wherein said second data is processed by said at least one submodule.

19. A system according to claim 1 wherein the or each script file includes a number which is used for authentication purposes by said system.

20. A system according to claim 19 wherein said number in hexadecimal format is chosen from a group consisting of:
Number 1:
b32b5b13ec6baefabf71d6654f45f29f3f54d13abd931c2e9552009ee2dcc23f98251f21712035 6bd1fee5b94ffc0dd5842f361887927 db5e4d599f5c026f6f29b26bedeaca7b592334859e2059de0d4bc54f79bf389b861ba85bd45b9b0be89ca5892181e2e842f7ba78e61f62ab0f4f58937940 6df47d1b11eaa2d90426d3
Number 2:
c8dea169cd564b3 dbf73fc2656712ce3503aaeea0dfd8fc6869e9ee7369449e288b40450496e69 4ca148cfb559b87ef2465d783c9d6d339f015695f582907761b10d55d38b3992fc6c95beb690f2 5e4f5015bb21d75bca3f1b9446899e9dfd0fa2c2173e8c6e3e9bd71352af6d71b8c462cbf86e02f6edd8c9d546eea96269c9
Number 3:
b2a4a7bffdea47c0318aef35dad8d3202dd934f67c6 cc25720b88ce978d62682e4187f0bb0d4f6 8b9004def865573c3752d153f1ca189eab34bb3bedd8592917ffc7d51adfa2eb6a5ee581720e3f 412e92b8310c25681e59a860d335458fac23bcdb4f9c049b06534efee2fe48c36f323396 db7726 5009924a979f839317479b
Number 4:
9c721bd382d73acf747197b590886f724856d1126a9d83b73fc093b390ddaed4469132ca238181a2631fc785c92a2461a270738446067b5f35e3586bb6eafd919fe0d825fd1e0f204a30356e9ed8 7d26a2338 db635a266b21df23aa4ffe0994ac2ff30748fd28049339eff1caaafea6d999cb8a019a0aaebe9902baa549e72b5
Number 5:
932edc5c8d17f26c045c8c042940068c1c7f7c9f6 cce160f468b50ce5c6bbb84c64b607c2b199f c151b3b7170158e985fc87deea46a443cab24e6be90aec343d9a28c1ce26af647ea84ffdcaf34b d46771965f4cae011c5734f3a7bdb5f7ec7a69f3c02645b938578ffb1dfed352f41573659e3d41 57e8602da0f94768d03189
Number 6:
c87541fa586b09864534ef4677e069e8208538f0578aa5689008d38932abae31def20a9336fddf 3a426fa7c08b3e1e15be4f6a6f16678b69ff6df725de0744c5e02c3cfb2a63adb99 dbc1a2a558b dd4a45f7f4b606b1c83f99d9ad65454ca21ac77bde29c89903e5f6a7c7e04307f6743c5a2555b7c3d27642758bafe87a2dad
Number 7:
b119fc0959e7c1bb55337e5867c69f316290fc8300408cd0a68088a2e81ee038005b39225377b2a1de22428ab0d5b36be761741d51fb57fe8d55c2566d7e7ef3f3da5301a333a83280ec57b80c5e 13b95985b4bb75f97f434fb3f50e10bb3eb5d013182a75b6f8a96de37d862e0742bc59a5512696a8dca2592856 db38 cc6adf
Number 8:
b2ff078d0c01a4ec0c5ce14faa9d340d5e66c2b01cb4876070c75741923f374b2fa5ea6f6fa30 0c22f841f15250cf0e85de606a0a33eb0b095d63d09068f70dafb3602930ef1bbd983525592bbb cdfe5bdada1d1e135585a2d09c2ae105f0f28980b646ae25a8e60b476e8fa906c915c4024734a4 9cbc165845e5c95fa49c85
Number 9:
a4dd6c5ef7fbdfdb4cb7d0d5175b37849df855bdc56eef307271cfc4042744c25099d67e31fa97 5eb3edffb3154ecf52dfa4287632a0ff21781e367a66a30663ff2f3c90f73c811112df34d52d47 6f3723f4 cc0874208c91e9003f0555b9d6c5c836e0c26d499d409c49ebb2ded21739b90148eb9f 85f5715f3b0204ebfa635d
Number 10:
c78e63d3de59c3ef33e3adb6916ee28c56a874d4d2330a85aed09f71289bb4468f15a2c669be8c 2f36ebfaf822793402ad2b01771d2ba91f4e9b8e1ce47e07c5f36aa5f3e5d5ca6fbb9b4ff6e5be d1cebb48fdba912d28b4be04cafa2 cc7fd3f8adea5511e590e3105a05fd8cbad8a0d5ef9960393 1e83e07f3f2944e82f0223
Number 11:
b7317af7b36d92e9df09aedf8aa4467b566075bddabe060ba96df705d61096d41cbfbf0d500fae a17f151dbe4dc395d0df8e48596324af6a7aff6e9fbc976586bb49043d6cd374b27631c64cf611c42ad63662719cdcc3c8a5129f796470c96e6bd0241aa91adbe0e2e1930bf17a45a1ded45f0172 728c0ba76d0461d6c4014b
Number 12:
e654ceb9f61cbe17da4fce548551d4 db641169d58bcbc5af62f91b2c581a71c3a0c93612f098 cc 8561197d2f87a01eeddefd92f063be64e5a5d0a07d84c097c57a02b16b899908ef837fc19741ff 2be91ca27cbbc0eba11c3c2a10cd30bda7e1aaaf3d09afb84ff92676a4722271561ef74b4d3f1 978a291dec943b51741e49
Number 13:
b9605 cc8071b0598bf639e9a95cab53ae0cb2fba22217b110c551dea3a5909a51b353670cd812d d4228656acff86b043765f9d8d8675bd7b2717 cc0c750e6bfcdcbc19be98c42bb430a5a985da19 838ca151947bb74872087677cb22439cee98002660e240e20868f6ed483d6d76f375483df0d1cf 4a9cf99834c58c52fc287b
Number 14:
a0772decbddf64f8bd52c3756895b66d211a28732a7ed37ea6e26793b3bcbb4c304c62ec373568 24a6554c2377fa14456a6b2e05de009588bf1d116e226557caeb719e1ccb885c5b8cd9e64147ba 36aa8165c40f5ffcf37e25ec8aed68d46b37bbba6f7878f331d6cf01fdad894146f153b02576a6d668059db3524c65a5f69d
Number 15:
a562a32df57d8020b62445ec71edbc302df8b9eb25d2bb5022811ea6c6b02020c3af6dd57c98d3e1672156e0322248c32d04bf506a599a14fd2f7177b84717ba1fe35c84aab276b8cb43df7f9aac 8605d687b4653732315742c776f4a982d0a4c41bf7a6c7a3ae29bfadc408ce4b2d493b97fe9220ff5c40108912c1c5e687a7
Number 16:
d58250a8136b0a79a1ef8336e095f80fab870eea27eb48 cc32534015a4c5e5397a178f4028290c 7704d82ee33a11821576ad36564b05e517252a56985fc1329687c184e5175bccf39bf9288169a6f43c3d8bfcdc461097f3096120f5318b7acae596598f0a9166a444af6ca6f59bf7b01a05c1eb75 1bd93ec3b8da3f6845d741
Number 17:
dd97e47a29c6b63a7 cc1e81121fe06f0f7705a1843672d2ef05b693fbfc9cfd97c06b9773 cc604a0dfd5b3b38c65908407c736466e6bf16e22188ae1cff536fc74d36693506f53be8d465c746ec 96c877ca8ca9d54b42ca90c380dda83459e95c92aa2205e820d28f981207292 cc0a0f6eade5b86e3d2c31bcd7f072f95460b
Number 18:
a44127d0d7d16a8d4c9ea254296d425c8009f015a84393dfe22ece621faa92c70c475319ddec78aee1ed72c664f630427845bd775d3e2c951eb65993ac2ac1ec71ca9ef2d47158458be2e84eeba2 2e178a60ef902a88aff6e18b62 cc744087bd6179109f932f7cf25e1c21f4f946852544cacb877e f064e4e04 cc15b51ee074b
Number 19:
dd438ac8b7fbd9689794946656d8b40c35a28f76c097338fa19c782a0255f50e9d5a5ecc474bb7 47d5a02699050e1f257daf2ae4f846bf6ee5415f365289bfc250ae968c44df8b2294a3daf2b2c8 109546a169c4f67f0c49a91602b4a2223fde6e24aa8b77b55072e78a9ea995b343846a25719f4a 9603fad300b12a465743c1
Number 20:
9f3c316e113c8a714013e5932786f1d749ba1776bad1a59c19f61a6be834754a1fb54e6158a817bb04837a6397831d7b454342bdc6952533e97b49c7961e5b608bdc0c41ab6fc28d50de0f2969e9e9b98c7d807756a1b9a6f41d083ed625b3177858723dfd83e5f0fd33b5a798cd806c8295351c76 449937924541e890385deb
Number 21:
be91216d523c7d82a86e4b2e31e96c078ec4a4d5bd162c9dc9ddf6fe6de8cadac13c9b2ada453b 0b006c98915a065e19cb24e6cd10ef262b4d96a62a14 db52dcb2f7de32f898e77da8b83e74fc4f c1cb1cb1f58dcfbfa0f2449d57f89b982423484014287490587c92cf22771e7a1c3447d9bb5456a49f4246a9df5d6d4fb12b
Number 22:
f1a28f3ad1e91bf83929f2 cca8faa60050e7d953e44be08e5c8806ad3e3a1a405da4cdee53e64f 6ce1189d77066e2152ce4f286c2058455073109682806a691e41d10e3166224efb4feb5b2ae3e2 4c8 db17f82574c7598defe07132581f8888d95ca72fb499e1ae3d53e4fe34ba41dc16a6898b653 4b7ba71fd36049a580b7c1
Number 23:
cb3a2367585ddf746e86f8f88f6eaac5cdf9baeab4d8aa16d25fd6239d95c6089c84d3bef80854dacdeeb2152d8eda8c78bfb55ea9e923bfefacca9d71dbb9f18f6f28af6a7a40d343056c67947a fdb69cd5354a155dafca48051194a184a3761430229d1022d9397839fbe6 db5781f372a4f8244a 3f3a334c45c7510238f33b
Number 24:
b4d0d35299d4a03a4dfaf77fb8d102fa17064521b0d985fd28419dddd8878c134b73e2a86fab13b56155322ffcc7f70c4dae3b9ae74aa1b1e71d6b79ed6dd3f27d87d32fec9d7e03be66ee56af7b 692a963a9cb6557b548feedc6c0f33a4be476185ff4ee6d8e5cdca813d0de5870a38b5b45450df 0cd9cefb90c1d9125 dbfa7
Number 25:
c2c58733f9aa7f3bda33f9a798311f94 dbe1d0ed0c8190ac248b1e527c29b3bb8d262a83f54d5e 82ca21524634311a740a1b31e26f37bac0816d3992c2006c06726cb80206a5d04be3b09fd150d 08305b587a06c7 cc5f1232f879f930fe30d95063a1134cf1ba064f959af64d0878fb42a43f97ae b18d4ede6a2adc9df2c305
Number 26:
d4a8cb2ff79569d82389a6250f9c59de0f3992ac94dcc8ea41cefedf54ea45 cc4e411774571dbe 38e78aa70f7523d8e1d3025b2d84040 db9396d1fc27b1e8067217d29f394aa225d534d7c8c664e 8e83059127cec8390cdb3867cd185da8bf45457695728e63df0c14e0cb2921aa552b33b174583d 0461dd7967b75bcdf5c7b3
Number 27:
a043b88b07205bd4835345 ccbb18e533 cccd4778b89016040288c60d06ddf1d7ed79933cab68c c1bd118fe8863ec8cbbf2f0ff019bc7c3f3543794ef889b4b3be118b835727537de9040b4175d0 79e73acef5ea475d158a2b18860ce5ab8d2ad8cf2b21ec1894d9ea5d2adc0fe3f49906fef48ae9 3f9c1d9c83a6704e18d5a7
Number 28:
b5ef3c5dac4be24ed7e4f9dddb977ebc6441738004a547939b5b689de7c50f98b93994e905bcbc ef896ac583895115f5891bbedd9d20c4d0bc9c656b3ec2c9379636d0a3420e333161860de3b57d 5677fbf415031098d7de8f1259e637e4ba31105b92c94bdaed82753b06b780cfe2fbec9e2034a 3018b8351bd2e2f1c614e7
Number 29:
baacd9fc6c4eaeaddc08383ab43de502fa0dd822f5fd6b958d966b8a8d2e1c2b304fe6a9c1640d d325e2372fdbebd9125f6c179a2aee91ab4f527acc6241691a15999d4de50df792203c3e7048f5a26729ab56cde31a050de313a7fe7b343586ac9147c1116ba17828331e930d13c218155f00703b f1c16f5e4170e2b81f59d9
Number 30:
b776876773cabe517edf254f8a1fd015dea55d1e1e1e2597abf583639b541a0fc85bbd6be5563 09fc4d486c12ddf63f24a34366a85e14eb30b6af3e52200d0e755b03fee2360446507b0ebce021e443b13e1411af11466dadc994e1733fc0dd24347e097d1bab5b938b67de888f78a1cd63d34e45a68816b4aa8a566a12aaad
Number 31:
d59664b6fad8a1c046711ea001124c8ca2d771a7f640ce32cb65238a92d199f3ab005863c97d 25d7794560a52546e13bb.7b3d7696d63a4575ca0db90596c885b1a13f384710c6d5170af7b4d 73959a2116df24c8e4daf45bdcd62c4ff3d97b755bf022dd2b62025ee086e9942fa000761678 9b5e0e0c39398526a96794640929

21. A system according to claim 1 wherein the or each script file includes a number which is used for security purposes by said system.

22. A system according to claim 21 wherein said number in hexadecimal format is chosen from a group consisting of:
Number 1:
b32b5b13ec6baefabf71d6654f45f29f3f54d13abd931c2e9552009ee2dcc23f98251f21712035 6bd1fee5b94ffc0dd5842f361887927 db5e4d599f5c026f6f29b26bedeaca7b592334859e2059de0d4bc54f79bf389b861ba85bd45b1b0be89ca5892181e2e842f7ba78e61f62ab0f4f58937940 6df47d1b11eaa2d90426d3
Number 2:
cdea169cd564b3 dbf73fc2656712ce3503aaeea0dfd8fc6869e9ee7369449e288b40450496e69 4ca148cfb559b87ef2465d783c9d6d339f015695f582907761b10d55d38b3992fc6c95beb690f2 5e4f5015bb21d75bca3f1b9446899edfd0fa2c2173e8c6e3e9bd71352af6d71b8c462cbf86e02f6edd8c9d546eea96269c9
Number 3:
b2a4a7bffdea47c0318aef35dad8d3202dd934f67c6 cc25720b88ce975d62682e4157f0bb0d4f6 8b9004def865573c3752d153f1ca189eab34bb3bedd8592917ffc7d51adfa2eb6a5ee581720e3f 412e92b8310c25681e59a860d335458fac23bcdb4f9c049b06534efee2fe48c36f323396 db7726 5009924a979f839317479b
Number 4:
9c721bd382d73acf747197b590886f724856d1126a9d83b73fc093b390ddaed4469132ca238181a2631fc785c92a2461a270738446067b5f35e3586bb6eafd919fe0d825fd1e0f204a30356e9ed8 7d26a2338 db635a266b21df23aa4ffe0994ac2ff30748fd28049339eff1caaafea6d999cb8a019a0aaebe9902baa549e72b5
Number 5:
932edc5c8d17f26c045c8c042940068c1c7f7c9f6 cce160f468b50ce8c6bbb84c64b607c2b199f c151b3b7170158e985fc87deea46a443cab24e6be90aec343d9a28c1ce26af647ea84ffdcaf34b d46771965f4cae011c5734f3a7bdb5f7ec7a69f3c02645b938578ffb1dfed352f41573659e3d41 57e8602daf94768d03189
Number 6:
c87541fa586b09864534ef4677e069e8208538f0578aa5689008d38932abae31def20a9336fddf 3a426fa7c08b3e1e15be4f6a6f16678b69ff6df725de0744c5e02c3cfb2a63adb99 dbc1a2a558b dd4a45f7f4b606b1c83f99d9ad65454ca21ac77bde29c89903e5f6a7c7e04307f6743c5a2555b7c3d27642758bafe87a2dad
Number 7:
b11gfc0959e7c1bb55337e5867c69f3162g0fc8300408cd0a68088a2e81ee038005b39225377b2a1de22428ab0d5b36be761741d51fb57fe8d55c2566d7e7ef3f3da5301a333a83280ec57b80c5e 13b95985b4bb75f97f434fb3f50e10bb3eb5d013182a75b6f8a96de37d862e0742bc59a5512696a8dca2592856 db38 cc6adf
Number 8:
b2ff078d08c01a4ec0c5ce14faa9d340de66c2b09cb4876070c75741923f374b2fa5ea6f6fa30 0c22f841f15250cf0e85de606a0a33eb0b095d63d09068f70dafb3602930ef1bbd983525592bbb cdfe5bdada1d1e135585a2d09c2ae105f0f28980b646ae25a8e60b476e8fa906c915c4024734a4 9cbc165845e5c95fa49c85
Number 9:
a4dd6c5ef7fbdfdb4cb7d0d5175b37849df855bdc56eef307271cfc4042744c25099d67e31fa97 5eb3edffb3154ecf52dfa4287632a0ff21781e367a66a30663ff2f3c90f73c811112df34d52d47 6f3723f4 cc0874208c91e9003f0555b9d6c5c836e0c26d499d409c49ebb2ded21739b90148eb9f 85f5715f3b0204ebfa635d
Number 10:
c78e63d3de59c3ef33e3adb6916ee28c56a874d4d2330a85aed09f71289bb4468f15a2c669be8c 2f36ebfaf822793402ad2b01771d2ba91f4e9b8e1ce47e07c5f36aa5f3e5d5ca6fbb9b4ff6e5be d1cebb48fdba912d28b4be04cafa2 cc7fd3f8adea5511e590e3105a05fd8cbad8a0def9960393 1e83e07f3f2944e82f0223
Number 11:
b7317af7b36d92e9df09aedf8aa4467b566075bddabe060ba96df705d61096d41cbfbfd500fae a17f151dbe4dc395d0df8e48596324af6a7aff6e9fbc976586bb49043d6cd374b27631c64cf611c42ad63662719cdcc3c8a5129f796470c96e6bd0241aa91adbete2e1930bf17a45a1ded45f0172 728c0ba76d0461d6c4014b
Number 12:
e654ceb9f61cbe17da4fce548551d4 db641169d58bcbc5af62f91b2c581a71c3a0c93612f098 cc 8561197d2f87a01eeddefd92f063be64e5a5d0a07d84c097c57a02b16b899908ef837fc19741ff 2be91ca27cbbc0eba11c3c2a10cd30bda7e1aaaf3d09a0fb84ff92676a4722271561ef74b4d3f1 978a291dec943b51741e49
Number 13:
b9605 cc8071b0598bf639e9a95cab53ae0cb2fba22217b110c551dea3a5909a51b353670cd812d d4228656acff86b043765f9d8d8675bd7b2717 cc0c750e6bfcdcbc19be98c42bb430a9a985da19 838ca151947bb74872087677cb22439cee98002660e240e20868f6ed483d6d76f375483df0d1cf 4a9cf99834c58c52fc287b
Number 14:
a0772decbddf64f8bd52c3756895b66d211a28732a7ed37ea6e26793b3bcbb4c304c62ec373568 24a6554c2377fa14456a6b2e05de009588bf1d916e226557caeb719e1ccb885c5b8cd9e64147ba 36aa8165c40f5ffcf37e25ec8aed68d46b37bbba6f7878f331d6cf01fdad894146f153b02576a6d668059 db3524c65a5f69d
Number 15:
a562a32df57d8020b62445ec71edbc302df8b9eb25d2bb5022811ea6c6b020c3af6dd57c98d3e1672156e0322248c32d04bf506a599a14fd2f7177b84717ba1fe35c84aab276b8cb43df7f9aac 8605d687b4653732315742c776f4a982d0a4c41bf7a6c7a3ae29bfadc408ce4b2d493b97fe9220ff5c40108912c1c5e687a7
Number 16:
d58250a8136b0a79a1ef8336e095f80fab870eea27eb48 cc32534015a4c5e5397a178f4028290c 7704d82ee33a11821576ad36564b05e517252a56985fc1329687c184e5175bccf39bf9288169a6f43c3d8bfcdc461097f3096120f5318b7acae596598f0a9166a444af6ca6f59bf7b01a05c1eb75 1bd93ec3b8da3f6845d741
Number 17:
dd97e47a29c6b63a7 cc1e81121fe06f0f7705a1843672d2ef05b693fbfc9cfd97c06b9773 cc604a0dfd5b3b38c65908407c736466e6bf16e22188ae1cff536fc74d36693506f53be8d465c746ec 96c877ca8ca9d54b42ca90c380dda83459e95c92aa2205e820d28f981207292 cc0a0f6eadeb86e3d2c31bcd7f072f95460b
Number 18:
a44127d0d7d16a8d4c9ea254296d425c8009f015a84393dfe22ece621faa92c70c475319ddec78aee1ed72c664f630427845bd775d3e2c951eb65993ac2ac1ec71ca9ef2d47158458be2e84eeba2 2e178a60ef902a88aff6e18b62 cc744087bd6179109f932f7cf25e1c21f4f946852544cacb877e f064e4e04 cc15b51ee074b
Number 19:
dd438ac8b7fbd9689794946656d8b40c35a28f76c097338fa19c782a0255f50e9d5a5ecc474bb7 47d5a02699050e1f257daf2ae4f846bf6ee5415f365289bfc250ae968c44df8b2294a3daf2b2c8 109546a169c4f67f0c49a91602b4a2223fde6e24aa8b77b55072e78a9ea995b343846a25719f4a 9603fad300b12a465743c1
Number 20:
9f3c316e113c8a714013e5932786f1d749ba1776bad1a59c11f61a6be834754a1fb54e6158a817bb04837a6397831d7b454342bdc6952533e97b49c7961e0b608bdc0c41ab6fc28d50def2969e9e9b98c7d807756a1b9a6f41d083ed625b3177858723dfd83e5f0fd33b5a798cd806c8295351c76 449937924541e890385deb
Number 21:
be91216d523c7d82a86e4b2e31e96c078ec4a4d5bd162c1dcgddf6fe6de8cadac13c1b2ada453b 0b016c98915a065e19cb24e6cd10ef262b4d96a62a14 db52dcb2f7de32f898e77da8b83e74fc4f c1cb1cb1f58dcfbfa0f2449d57f89b982423484014287490587c92cf22771e7a1c3447d9bb5456a49f4246a9df5d6d4fb12b
Number 22:
f1a28f3ad1e91bf83929f2 cca8faa60050e7d953e44be08e5c8806ad3e3a1a405da4cdee53e64f 6ce1189d77066e2152ce4f286c2058455073109682806a691e41d10e3166224efb4feb5b2ae3e2 4c8 db17f82574c7598defe07132581f8888d95ca72fb499e1ae3d53e4fe34ba41dc16a6898b653 4b7ba71fd36049a580b7c1
Number 23:
cb3a2367585ddf746e86f8f88f6eaac5cdf9baeab4d8aa16d25fd6239d95c6089c84d3bef80854dacdeeb2152d8eda8c78bfb55ea9e923bfefacca9d71dbb9f18f6f28af6a7a40d343056c67947a fdb69cd5354a155dafca48051194a184a3761430229d1022d9397839fbe6 db5781f372a4f8244a 3f3a334c45c7510238f33b
Number 24:
b4d0d35299d4a03a4dfaf77fb8d102fa17064521b0d985fd28419dddd8878c134b73e2a86fab13b56155322ffcc7f70c4dae3b9ae74aa1b1e71d6b79ed6dd3f27d87d32fec9d7e03be66ee56af7b 692a963a9cb6557b548feedc6c0f33a4be476185ff4ee6d8e5cdca813d0de5870a38b5b45450df 0cd9cefb90c1d9125 dbfa7
Number 25:
c2c58733f9aa7f3bda33f9a798311f94 dbe1d0ed0c8190ac248b1e527c29b3bb8d262a83f54d5e 82ca21524634311a740a1b31e26f37bac08816d3992c2006c06726cb80206a5d04be3b09fd150d 08305b587a06c7 cc5f1232f879f930fe30d95063a1134cf1ba064f959af64d0878fb42a43f97ae b18d4ede6a2adc9df2c305
Number 26:
d4a8cb2ff79569d82389a6250f9c59de0f3992ac94dcc8ea41cefedf54ea45 cc4e411774571dbe 38e78aa70f7523d8e1d3025b2d84040 db9396d1fc27b9e8067217d29f394aa225d534d7c8c664e 8e83059127cec8390cdb3867cd185da8bf45457695728e63df5c14e0cb2921aa552b33b174583d 0461dd7967b75bcdf5c7b3
Number 27:
a043b88b07205b8d4835345 ccbb18e533 cccd4778b89016040288c60d06ddf1d7ed79933cab68c c1bd11fe8863ec8cbbf2f0ff019bc7c3f3543794ef889b4b3be118b835727537de9040b4175d0 79e73acefea475d158a2b18860ceab8d2ad8cf2b21ec1894d9ea5d2adc0fe3f49906fef48ae9 3f9c1d9c83a6704e18d5a7
Number 28:
b5ef3c5dac4be24ed7e4f9dddb977ebc6441738004a547939b5b689de7c50f98b93994e905bcbc ef896ac583895115f5891bbedd9d20c4d0bc9c656b3e29379636d0a3420e333161860de3b57d 5677fbf415031098d7de8f1259e637e4ba31105b92c94bdaed82753b06b780cfe2fbec9e2034a 3018b8351bd2e2f1c614e7
Number 29:
baacd9fc6c4eaeaddc08383ab43de502fa0dd822f5fd6b958d966b8a8d2e1c2b304fe6a9c1640d d325e2372fdbebd9125f6c179a2aee91ab4f527acc6241691a15999d4de50df792203c3e7048f5a26729ab56cde31a050de313a7fe7b343586ac9147c1116ba17828331e930d13c218155f00703b f1c16f5e4170e2b81f59d9
Number 30:
b776876773cabe517edf254f8a1fd015dea55d1e1e1e2597abf583639b541a0fc85bbd6be5563 09fc4d486c12ddf63f24a34366a85e14eb30b6af3e52200d0e755b03fee2360446507b0ebce021e443b13e1411af11466dadc994e1733fc0dd24347e097d1bab5b938b67de888f78a1cd63d34e45a68816b4aa8a566a12aaad
Number 31:
d59664b6fad8a1c046711ea001124c8ca2d771a7f640ce32cb65238a92d199f3ab005863c97d 25d7794560a52546e13bb7b3d7696d63a4575ca0db90596c885b1a13f384710c6d5170af7b4d 73959a2116df24c8e4daf45bdcd62c4ff3d97b755bf022dd2b62025ee086e9942fa000761678 9b5e0e0c39398526a96794640929

23. A graphical user interface for use in a software application for information retrieval from at least one networked information source the interface comprising:
a main section occupying a first portion of a user screen;
at least one subsidiary section, the or each subsidiary section occupying a portion of the user screen separate and independent from each other section, the or each subsidiary section corresponding to one networked information source wherein the or each subsidiary section contains at least one first indicia relating to a specific information item stored on a networked information source corresponding to said subsidiary section.

24. A graphical user interface according to claim 23 wherein the or each subsidiary section has a second indicia to identify a networked information source corresponding to said subsidiary section.

25. A graphical user interface according to claim 23 wherein the or each subsidiary section has a third indicia to indicate an amount of information items on said networked information source corresponding to said subsidiary section that has not been accessed by a user.

26. A graphical user interface according to claim 24 wherein the second indicia is an icon.

27. A graphical user interface according to claim 25 wherein said third indicia is a number.

28. A graphical user interface according to claim 23 wherein said at least one first indicia comprises text.

29. A graphical user interface according to claim 28 wherein said text is a summary of said information items.

30. A graphical user interface according to claim 28 wherein said information items are chosen from a group consisting of:
news items;
electronic mail messages;
data related to email messages;
network messaging content;
online messaging content;
online tracking indicating which members of a specific group of people are online;
weather reports;
stock and/or investment data;
price indicators for user selected items from specific websites;
current bid prices for selected items at specified online auctions;
software updates for specific software packages;
software additions for specific software packages;
news items;
data relating to most recent changes at user specified websites;
data relating to process for travel and/or vacations;
sports news items;
data related to a specific user's horoscope/astrology;
data related to problems with specific software packages;
data related to voice telephony;
data related to a specific user's calendar;
data related to a specific user's customized list;
data related to a specific user's voice mail;
data related to entertainment content specifically selected by a specific user;
data related to advertising by specific business entities;
data related to a video camera monitoring a specific area; and
data related to a specific online message board.

31. A graphical user interface according to claim 30 wherein said information items are news items and said text comprises headlines of said news items.

32. A graphical user interface according to claim 30 wherein said information items are electronic mail messages and said text comprises subject lines for said electronic mail messages.

33. A graphical user interface according to claim 23 wherein the or each first indicia can be activated by a user.

34. A graphical user interface according to claim 33 wherein user activation of said at least one first indicia causes retrieval of an information item corresponding to said at least one indicia.

35. A file readable by a computing device, the file being for use with an information retrieval application for retrieving data related to information items stored at an information source, the file comprising:
a source field containing address data relating to an address location, said network address location being a location where said data is stored;
a script field containing instructions for said application on how said data is to be processed.

36. A file according to claim 35 wherein said data relating to an address location is a network address, said network address being a location to a network where said data is stored.

37. A file according to claim 36 wherein said network is chosen from a group consisting of
the Internet;
a wide area network; and
a local area network.

36. A file according to claim 36 said file including:
an icon field identifying said address location, said address location containing an iconic representation of an identity of said information source.

39. A file according to claim 38 said file including:
a link field identifying a default location for said iconic representation which is accessed when a user activates said iconic representation after said iconic representation is presented to said user.

40. A file according to claim 36 wherein said file includes a storage field identifying a location in a network which can be periodically queried by said application to determine if newer versions of said file are available.

41. A file according to claim 36 wherein said file includes a fingerprint field containing authenticating means for authenticating said file to said application.

42. A file according to claim 41 wherein said authenticating means is a string of alphanumeric characters for decryption by said application.

43. A file according to claim 41 wherein said authenticating means is a hexadecimal number.

44. A file according to claim 43 wherein said hexadecimal number is used for encrypting or decrypting purposes by said application.

45. A file according to claim 44 wherein said number is chosen from a group consisting of:
Number 1:
b32b5b13ec6baefabf71d6654f45f29f3f54d13abd931c2e9552009ee2dcc23f98251f21712035 6bd1fee5b94ffc0dd5842f361887927 db5e4d599f5c026f6f29b26bedeaca7b592334859e2059de0d4bc54f79bf389b861ba85bd45b9b0be89ca5892181e2e842f7ba78e61f62ab0f4f58937940 6df47d1b11eaa2d90426d3
Number 2:
c8dea169cd564b3 dbf73fc2656712ce3503aaeea0dfd8fc6869e9ee7369449e285b40450496e69 4ca148cfb559b87ef2465d783c9d6d339f015695f582907761b10d55d38b3992fc6c95beb690f2 5e4f5015bb21d75bca3f1b9446899e9dfd0fa2c2173e8c6e3e9bd71352af6d71b8c462cbf86e02f6edd8c9d546eea96269c9
Number 3:
b2a4a7bffdea47c0318aef35dad8d3202dd934f67c6 cc25720b88ce978d62682e4187f0bb0d4f6 8b9004def865573c3752d153f1ca189eab34bb3bedd8592917ffc7d51adfa2eb6a5ee581720e3f 412e92b8310c25681e59a860d335458fac23bcdb4f9c049b06534efee2fe48c36f323396 db7726 5009924a979f839317479b
Number 4:
9c721bd382d73acf747197b590886f724856d1126a9d83b73fc093b390ddaed4469132ca236181a2631fc785c92a2461a270738446067b5f35e3586bb6eafd919fe0d825fd1e0f204a30356e5ed8 7d26a2338 db635a266b21df23aa4ffe0994ac2ff30748fd28049339eff1caaafea6d999cb8a019a0aaebe9902baa549e72b5
Number 5:
932edc5c8d17f26c045c8c042940068c1c7f7c9f6 cce160f468b50ce8c6bbb84c64b607c2b199f c151b3b7170158e985fc87deea46a443cab24e6be90aec343d9a28c1ce26af647ea84ffdcaf34b d46771965f4cae011c5734f3a7bdb5f7ec7a69f3c02645b938578ffb1dfed352f41573659e3d41 57e8602da0f94768d03189
Number 6:
c87541fa586b09864534ef4677e069e8208538f0578aa5689008d38932abae31def20a9336fddf 3a426fa7c08b3e1e15be4f6a6f16678b69ff6df725de0744c5e02c3cfb2a63adb99 dbc1a2a558b dd4a45f7f4b606b1c83f99d9ad65454ca21ac77bde29c89903e5f6a7c7e04307f6743c5a2555b7c3d27642758bafe87a2dad
Number 7:
b119fc0959e7c1bb55337e5867c69f316290fc8300408cd0a68088a2e81ee038005b39225377b2a1de22428ab0d5b36be761741d51fb57fe8d55c2566d7e7ef3f3da5301a333a83280ec57b80c5e 13b95985b4bb75f97f434fb3f50e10bb3eb5d013182a75b6f8a96de37d862e0742bc59a5512696a8dca2592856 db38 cc6adf
Number 8:
b2ff078d08c01a4ec0c5ce14faa9d340d5e66c2b09cb4876070c75741923f374b2fa5ea6f6fa30 0c22f841f15250cf0e85de606a0a33eb0b095d63d09068f70dafb3602930ef1bbd983525592bbb cdfebdada1d1e135585a2d09c2ae105f0f28980b646ae25a8e60b476e8fa906c915c4024734a4 9cbc165845e5c95fa49c85
Number 9:
a4dd6c5ef7fbdfdb4cb7d0d5175b37849df855bdc56eef307271cfc4042744c25099d67e31fa97 5eb3edffb3154ecf52dfa4287632a0ff21781e367a66a30663ff2f3c90f73c811112df34d52d47 6f3723f4 cc0874208c91e9003f0555b9d6c5c836e0c26d499d409c49ebb2ded21739b90148eb9f 85f5715f3b0204ebfa635d
Number 10:
c78e63d3de59c3ef33e3adb6916ee28c56a874d4d2330a85aed09f71289bb4468f15a2c669be8c 2f36ebfaf822793402ad2b01771d2ba91f4eb8e1ce47e07c5f36aa5f3e5d5ca6fbb1b4ff6e5be d1cebb48fdba912d28b4be04cafa2 cc7fd3f8adea5511e590e3105a05fd8cbad8a0d5ef9960393 1e83e07f3f2944e82f0223
Number 11:
b7317af7b36d92e9df09aedf8aa4467b566075bddabe060ba96df705d61096d41cbfbf0d500fae a17f151dbe4dc395d0df8e48596324af6a7aff6e9fbc976586bb49043d6cd374b27631c64cf611c42ad63662719cdcc3c8a5129f796470c96e6bd0241aa91adbe0e2e1930bf17a45a1ded45f0172 728c0ba76d0461d6c4014b
Number 12:
e654ceb9f61cbe17da4fce548551d4 db641169d58bcbc5af62f91b2c581a71c3a0c93612f098 cc 8561197d2f87a01eeddefd92f063be64e5a5d0a07d84c097c57a02b16b899908ef837fc19741ff 2be91ca27cbbc0eba11c3c2a10cd30bda7e1aaaf3d09a0fb84ff92676a4722271561ef74b4d3f1 978a291dec943b51741e49
Number 13:
b9605 cc8071b0598bf639e9a95cab53ae0cb2fba22217b110c551dea3a5909a51b353670cd812d d4228656acff86b043765f9d8d8675bd7b2717 cc0c750e6bfcdcbc19be98c42bb430a9a985da19 838ca151947bb74872087677cb22439cee98002660e240e20868f6ed483d6d76f375483df0d1cf 4a9cf99834c58c52fc287b
Number 14:
a0772decbddf64f8bd52c3756895b66d211a28732a7ed37ea6e26793b3bcbb4c304c62ec373568 24a6554c2377fa14456a6b2e05de009588bf1d916e226557caeb719e1ccb885c5bcd9e64147ba 36aa8165c40f5ffcf37e25ec8aed68d46b37bbba6f7878f331d6cf01fdad894146f153b02576a6d668059 db3524c65a5f69d
Number 15:
a562a32df57d8020b62445ec71edbc302df8b9eb25d2bb5022811ea6c6b02020c3af6dd57c98d3e1672156e0322248c32d04bf506a599a14fd2f7177b84717ba1fe35c84aab276b8cb43df7f9aac 8605d687b4653732315742c776f4a982d0a4c41bf7a6c7a3ae29bfadc408ce4b2d493b97fe9220ff5c40108912c1c5e687a7
Number 16:
d58250a8136b0a79a1ef8336e095f80fab870eea27eb48 cc32534015a4c5e5397a178f4028290c 7704d82ee33a11821576ad36564b05e517252a56985fc1329687c184e5175bccf39bf9288169a6f43c3d8bfcdc461097f3096120f5318b7acae596598f0a9166a444af6ca6f59bf7b01a05c1eb75 1bd93ec3b8da3f6845d741
Number 17:
dd97e47a29c6b63a7cc1e81121fe06f0f7705a1843672d2ef05b693fbfc9cfd97c06b9773cc604a0dfd5b3b38c65908407c736466e6bf16e22188ae1c8ff536fc74d36693506f53be5d465c746ec 96c877ca8ca9d54b42ca90c380dda83459e95c92aa2205e820d28f981207292 cc0a0f6eade5b86e3d2c31bcd7f072f95460b
Number 18:
a44127d0d7d16a8d4c9ea254296d425c8009f015a84393dfe22ece621faa92c70c475319ddec78aee1ed72c664f630427845bd775d3e2c951eb65993ac2ac1ec71ca9ef2d47158458be2e84eeba2 2e178a60ef902a88aff6e18b62 cc744087bd6179109f932f7cf25e1c21f4f946852544cacb877e f064e4e04 cc15b51ee074b
Number 19:
dd438ac8b7fbd9689794946656d8b40c35a28f76c097338fa19c782a0255f50e9d5a5ecc474bb7 47d5a02699050e1f257daf2ae4f846bf6ee5415f365289bfc250ae968c44df8b2294a3daf2b2c8 109546a169c4f67f0c49a91602b4a2223fde6e24aa8b77b55072e78a9ea995b343846a25719f4a 9603fad300b12a465743c1
Number 20:
9f3c316e113c8a714013e5932786f1d749ba1776bad9a59c19f61a6be834754a1fb54e6158a817bb04837a6397831d7b454342bdc6952533e97b49c7961e0b608bdc0c41ab6fc28d50de0f2969e9e9b98c7d807756a1b9a6f41d083ed625b3177858723dfd83e5f0fd33b5a798cd806c8295351c76 449937924541e890385deb
Number 21:
be91216d523c7d82a86e4b2e31e96c078ec4a4d5bd162c9dc9ddf6fe6de8cadac13c9b2ada453b 0b016c98915a065e19cb24e6cd10ef262b4d96a62a14 db52dcb2f7de32f898e77da8b83e74fc4f c1cb1cb1f58dcfbfa0f2449d57f89b982423484014287490587c92cf22771e7a1c3447d9bb5456a49f4246a9df5d6d4fb12b
Number 22:
f1a28f3ad1e91bf83929f2 cca8faa60050e7d953e44be08e5c8806ad3e3a1a405da4cdee53e64f 6ce1189d77066e2152ce4f286c2058455073109682806a691e41d10e3166224efb4feb5b2ae3e2 4c8 db17f82574c7598defe07132581f8888d95ca72fb499e1ae3d53e4fe34ba41dc16a6898b653 4b7ba71fd36049a580b7c1
Number 23:
cb3a2367585ddf746e86f8f88f6eaac5cdf9baeab4d8aa16d25fd6239d95c6089c84d3bef80854dacdeeb2152d8eda8c78bfb55ea9e923bfefacca9d71dbb9f18f6f28af6a7a40d343056c67947a fdb69cd5354a155dafca48051194a184a3761430229d1022d9397839fbe6 db5781f372a4f8244a 3f3a334c45c7510238f33b
Number 24:
b4d0d35299d4a03a4dfaf77fb8d102fa17064521b0d985fd2841gdddd8878c134b73e2a86fab13b56155322ffcc7f70c4dae3b9ae74aa1b1e71d6b79ed6dd3f27 d87d32fec9d7e03be66ee56af7b 692a963a9cb6557b548feedc6c0f33a4be476185ff4ee6d8e5cdca813d0de5870a38b5b45450df 0cd9cefb90c1d9125 dbfa7
Number 25:
c2c58733f9aa7f3bda33f9a798311f94 dbe1d0ed0c8190ac248b1e527c29b3bb8d262a83f54d5e 82ca21524634311a740a1b31e26f37bac08816d3992c2006c06726cb80206a5d04be3b09fd150d 08305b587a06c7 cc5f1232f879f930fe30d95063a1134cf1ba064f959af64d0878fb42a43f97ae b18d4ede6a2adc9df2c305
Number 26:
d4a8cb2ff79569d8238ga6250f9c59de0f3992ac94dcc8ea41cefedf54ea45 cc4e411774571dbe 38e78aa70f7523d8e1d3025b2d84040 db9396d1fc27b9e8067217d29f394aa225d534d7c8c664e 8e83059127cec8390cdb3867cd185da8bf45457695728e63dfc14e0cb2921aa552b33b174583d 0461dd7967b75bcdf5c7b3
Number 27:
a043b88b07205b8d4835345 ccbb18e533 cccd4778b89016040288c60d06ddf1d7ed79933cab68c c1bd118fe8863ec8cbbf2f0ff019bc7c3f3543794ef889b4b3be118b835727537de9040b4175d0 79e73acef5ea475d158a2b18860ce9ab8d2ad8cf2b21ec1894d9ea5d2adc0fe3f49906fef48ae9 3f9c1d9c83a6704e18d5a7
Number 28:
b5ef3c5dac4be24ed7e4f9dddb977ebc6441738004a547939b5b689de7c50f98b93994e905bcbc ef896ac583895115f5891bbedd9d20c4d0bc9c656b3ec2c9379636d0a3420e333161860de3b57d 5677fbf415031098d7de8f1259e637e4ba31105b92c94bdaed82753b06b780cfe2fbec9e2034a 3018b8351bd2e2f1c614e7
Number 29:
baacd9fc6c4eaeaddc08383ab43de502fa0dd822f5fd6b958d966b8a8d2e1c2b304fe6a9c1640d d325e2372fdbebd9125f6c179a2aeeg1ab4f527acc6241691a15999d4de50df792203c3e7048f5a26729ab56cde31a050de313a7fe7b343586ac1147c1116ba17828331e930d13c218155f00703b f1c16f5e4170e2b81f59d9
Number 30:
b776876773cabe517edf254f8a10fd015dea55d1e1e1e2597abf583639b541a0fc85bbd6be5563 09fc4d486c12ddf63f24a34366a85e14eb30b6af3e52200d0e755b03fee2360446507b0ebce021e443b13e1411af11466dadc994e1733fc0dd24347e097d1bab5b938b67de888f78a1cd63d34e45a68816b4aa8a566a12aaad
Number 31:
d59664b6fad8a1c046711ea001124c8ca2d771a7f640ce32cb65238a92d199f3ab005863c97d 25d7794560a52546e13bb7b3d7696d63a4575ca0db90596c885b1a13f384710c6d5170af7b4d 73959a2116df24c8e4daf45bdcd62c4ff3d97b755bf022dd2b62025ee086e9942fa000761678 9b5e0e0c39398526a96794640929

46. A method for retrieving data from a first networked information source, the method comprising the steps of:
a) accessing a specific file corresponding to said first networked information source;
b) locating a portion of said specific file said portion denoting a network address for said first networked information source.
c) communicating with said first networked information source using said network address; and
d) retrieving contents of a data file at said network address, said data file containing said data, said data relating to information items stored at a second networked information source.

47. A method according to claim 46 wherein said specific file comprises:
a source field containing a network address, said network address being a location in a network where said data is stored;
a script field containing instructions for said application on how said data is to be processed.

48. A method according to claim 46 wherein said at least a portion of said data is presented to a user using graphical user interface, said interface comprising:
a main section occupying a first portion of a user screen;
at least one subsidiary section, the or each subsidiary section occupying a portion of the user screen separate and independent from each other section, the or each subsidiary section corresponding to one networked information source wherein the or each subsidiary section contains at least one fist indicia relating to a specific information item stored on a networked information source corresponding to said subsidiary section.

49. A method according to claim 47 wherein said specific file includes a fingerprint field containing authenticating means for authenticating said file to a software application.

50. A file according to claim 41 wherein said authenticating means is a hexadecimal number chosen from a group consisting of:
Number 1:
b32b5b13ec6baefabf71d6654f45f29f3f54d13abd931c2e9552009ee2dcc23f98251f21712035 6bd1fee5b94ffc0dd5842f361887927 db5e4d599f5c026f6f29b26be0deaca7b592334859e2059de0d4bc54f79bf389b861ba85bd45b9b0be89ca5892181e2e842f7ba78e61f62ab0f4f58937940 6df47d1b11eaa2d90426d3
Number 2:
c8dea169cd564b3 dbf73fc2656712ce3503aaeea0dfd8fc6869e9ee7369449e288b40450496e69 4ca148cfb559b87ef2465d783c9d6d339f015695f582907761b10d55d38b3992fc6c95beb690f2 5e4f5015bb21d75bca3f1b9446899e9dfd0fa2c2173e8c6e3e9bd71352af6d71b8c462cbf86e02f6edd8c9d546eea96269c9
Number 3:
b2a4a7bffdea47c0318aef35dad8d3202dd934f67c6 cc25720b88ce978d62682e4187f0bb0d4f6 8b9004def865573c3752d153f1ca189eab34bb3bedd8592917ffc7d51adfa2eb6a5ee581720e3f 412e92b8310c25681e59a860d335458fac23bcdb4f9c049b06534efee2fe48c36f323396 db7726 5009924a979f839317479b
Numnber 4:
9c721bd382d73acf747197b590886f724856d1126a9d83b73fc093b390ddaed4469132ca238181a2631fc785c92a2461a270738446067b5f35e3586bb6eafd919fe0d825fd1e0f204a30356e9ed8 7d26a2338 db635a266b21df23aa4ffe0994ac2ff30748fd28049339eff1caaafea6d999cb8a019a0aaebe9902baa549e72b5
Number 5:
932edc5c8d17f26c045c8c042940068c1c7f7c9f6 cce160f468b50ce8c6bbb84c64b607c2b199f c151b3b7170158e985fc87deea46a443cab24e6be90aec343d9a28c1ce26af647ea84ffdcaf34b d46771965f4cae011c5734f3a7bdb5f7ec7a69f3c02645b938578ffb1dfed352f41573659e3d41 57e8602da0f94768d03189
Number 6:
c87541fa586b09864534ef4677e069e8208538f0578aa5689008d38932abae31def20a9336fddf 3a426fa7c08b3e1e15be4f6a6f16678b69ff6df725de0744c5e02c3cfb2a63adb99 dbc1a2a558b dd4a45f7f4b606b1c83f99d9ad65454ca21ac77bde29c89903e5f6a7c7e04307f6743c5a2555b7c3d27642758bafe87a2dad
Number 7:
b119fc0959e7c1bb55337e5867c69f316290fc8300408cd0a68088a2e81ee038005b39225377b2a1de22428ab0d5b36be761741d51fb57fe8d55c2566d7e7ef3f3da5301a333a83280ec57b80c5e 13b95985b4bb75f97f434fb3f50e10bb3eb5d013182a75b6f8a96de37d862e0742bc59a5512696a8dca2592856 db38 cc6adf
Number 8:
b2ff078d08c01a4ec0c5ce14faa9d340d5e66c2b09cb4876070c75741923f374b2fa5ea6f6fa30 0c22f841f15250cf0e85de606ata33eb0b095d63d09068f70dafb3602930ef1bbd983525592bbb cdfe5bdada1d1e135585a2d09c2ae105f0f28980b646ae25a8e60b476e8fa906c915c4024734a4 9cbc165845e5c95fa49c85
Number 9:
a4dd6c5ef7fbdfdb4cb7d0d5175b37849df855bdc56eef307271cfc4042744c25099d67e31fa97 5eb3edffb3154ecf52dfa4287632a0ff21781e367a66a30663ff2f3c90f73c811112df34d52d47 6f3723f4 cc0874208c91e9003f0555b9d6c5c836e0c26d499d409c49ebb2ded21739b90148eb9f 85f5715f3b0204ebfa635d
Number 10:
c78e63d3de59c3ef33e3adb6916ee28c56a874d4d2330a85aed09f71289bb4466f15a2c669be8c 2f36ebfaf822793402ad2b01771d2ba91f4e9b8e1ce47e07c5f36aa5f3e5d5ca6fbb9b4ff6e5be d1cebb48fdba912d28b4be04cafa2 cc7fd3f8adea5511e590e3105a05fd8cbad8a0d5ef9960393 1e83e07f3f2944e82f0223
Number 11:
b7317af7b36d92e9df09aedf8aa4467b566075bddabe006ba96df705d61096d41cbfbf0d500fae a17f151dbe4dc395d0df8e48596324af6a7aff6e9fbc976586bb49043d6cd374b27631c64cf611c42ad63662719cdcc3c8a5129f796470c96e6bd0241aa91adbe0e2e1930bf17a45a1ded45f0172 728c0ba76d0461d6c4014b
Number 12:
e654ceb9f61cbe17da4fce548551d4 db641169d58bcbc5af62fg1b2c581a71c3a0c93612f098 cc 8561197d2f87a01eeddefd92f063be64e5a5d0a07d84c097c57a02b16b899908ef837fc19741ff 2be91ca27cbbc0eba11c3c2a10cd30bda7e1aaaf3d0a0fb84ff92676a4722271561ef74b4d3f1 978a291dec943b51741e49
Number 13:
b9605 cc8071b0598bf639e9a95cab53ae0cb2fba22217b110c551dea3a5909a51b353670cd812d d4228656acff86b043765f9d8d8675bd7b2717cc0c750e6bfcdcbc19be98c42bb430a9a985da19 838ca151947bb74872087677cb22439cee98002660e240e20868f6ed483d6d76f375483df0d1cf 4a9cf99834c58c52fc287b
Number 14:
a0772decbddf64f8bd52c3756895b66d211a28732a7ed37ea6e26793b3bcbb4c304c62ec373568 24a6554c2377fa14456a6b2e05de009588bf1d916e226557caeb719e1ccb885c5b8cd9e64147ba 36aa8165c40f5ffcf37e25ec8aed68d46b37bbba6f7878f331d6cf01fdad894146f153b02576a6d668059 db3524c65a5f69d
Number 15:
a562a32df57d8020b62445ec71edbc302df8b9eb25d2bb5022811ea6c6b02020c3af6dd57c98d3e1672156e0322248c32d04bf506a599a14fd2f7177b84717ba1fe35c84aab276b8cb43df7f9aac 8605d687b4653732315742c776f4a982d0a4c41bf7a6c7a3ae29bfadc408ce4b2d493b97fe9220ff5c40108912c1c5e687a7
Number 16:
d58250a8136b0a79a1ef8336e095f80fab870eea27eb48 cc32534015a4c5e5397a178f4028290c 7704d82ee33a11821576ad36564b05e517252a56985fc1329687c184e5175bccf39bf9288169a6f43c3d8bfcdc461097f3096120f5318b7acae596598f0a9166a444af6ca6f59bf7b01a05c1eb75 1bd93ec3b8da3f6845d741
Number 17:
dd97e47a29c6b63a7 cc1e81121fe06f0f7705a1843672d2ef05b693fbfc9cfd97c06b9773 cc604a5dfd5b3b38c65908407c736466e6bf16e22188ae1c8ff536fc74d36693506f53be8d465c746ec 96c877ca8ca9d54b42ca90c380dda83459e95c92aa2205e820d28f981207292 cc0a0f6eade5b86e3d2c31bcd7f072f95460b
Number 18:
a44127d0d7d16a8d4c9ea254296d425c8009f015a84393dfe22ece621faa92c70c475319ddec78aee1ed72c664f630427845bd775d3e2c951eb65993ac2ac1ec71ca9ef2d47158458be2e84eeba2 2e178a60ef902a88aff6e18b62 cc744087bd6179109f932f7cf25e1c21f4f946852544cacb877e f064e4e04 cc15b51ee074b
Number 19:
dd438ac8b7fbd9689794946656d8b40c35a28f76c097338fa11c782a0255f50ed5a5ecc474bb7 47d5a02699050e1f257daf2ae4f846bf6ee5415f365289bfc250ae968c44df8b2294a3daf2b2c8 109546a169c4f67f0c49a91602b4a2223fde6e24aa8b77b55072e78a9ea995b343846a25719f4a 9603fad300b12a465743c1
Number 20:
9f3c316e113c8a714013e5932786f1d749ba1776bad9a59c19f61a6be834754a1fb54e6158a817bb04837a6397831d7b454342bdc6952533e97b49c7961e0b608bdc0c41ab6fc28d50de0f2969e9e9b98c7d807756a1b9a6f41d083ed625b3177858723dfd83e5f0fd33b5a798cd806c8295351c76 449937924541e890385deb
Number 21:
be91216d523c7d82a86e4b2e31e96c078ec4a4d5bd162c9dc9ddf6fe6de8cadac13c9b2ada453b 0b016c98915a065e19cb24e6cd10ef262b4d96a62a14 db52dcb2f7de32f898e77da8b83e74fc4f c1cb1cb1f58dcfbfa0f2449d57f89b982423484014287490587c92cf22771e7a1c3447d9bb5456a49f4246a9dfd6d4fb12b
Number 22:
f1a28f3ad1e91bf83929f2 cca8faa60050e7d953e44be08e5c8806ad3e3a1a405da4cdee53e64f 6ce1189d77066e2152ce4f286c2058455073109682806a691e41d10e3166224efb4feb5b2ae3e2 4c8 db17f82574c7598defe07132581f8888d95ca72fb499e1ae3d53e4fe34ba41dc16a6898b653 4b7ba71fd36049a580b7c1
Number 23:
cb3a2367585ddf746e86f8f88f6eaac5cdf9baeab4d8aa16d25fd6239d95c6089c84d3bef80854dacdeeb2152d8eda8c78bfb55ea9e923bfefacca9d71dbb9f18f6f28af6a7a40d343056c67947a fdb69cd5354a155dafca48051194a184a3761430229d1022d9397839fbe6 db5781f372a4f8244a 3f3a334c45c7510238f33b
Number 24:
b4d0d35299d4a03a4dfaf77fb8d102fa17064521b0d985fd28419dddd8878c134b73e2a86fab13b56155322ffcc7f70c4dae3b9ae74aa1b1e71d6b79ed6dd3f27d87d32fec1d7e03be66ee56af7b 692a963a9cb6557b548feedc6c0f33a4be476185ff4ee6d8e5cdca813d0de5870a38b5b45450df 0cd9cefb90c1d9125 dbfa7
Number 25:
c2c58733f9aa7f3bda33f1a798311f94 dbe1d0ed0c8190ac248b1e527c29b3bb8d262a83f54d5e 82ca21524634311a740a1b31e26f37bac08816d3992c2006c06726cb80206a5d04be3b09fd150d 08305b587a06c7 cc5f1232f879f930fe30d95063a1134cf1ba064f959af64d0878fb42a43f97ae b18d4ede6a2adc9df2c305
Number 26:
d4a8cb2ff79569d82389a6250f1c59de0f3992ac94dcc8ea41cefedf54ea45 cc4e411774571dbe 38e78aa70f7523d8e1d3025b2d84040 db9396d1fc27b9e8067217d29f394aa225d534d7c8c664e 8e83059127cec8390cdb3867cd185da8bf45457695728e63dfc14e0cb2921aa552b33b174583d 0461dd7967b75bcdf5c7b3
Number 27:
a043b88b07205b8d4835345 ccbb18e533 cccd4778b89016040288c60d06ddf1d7ed79933cab68c c1bd118fe8863eccbbf2f0ff019bc7c3f3543794ef889b4b3be118b835727537de9040b4175d0 79e73acef5ea475d158a2b18860ce9ab8d2ad8cf2b21ec1894d9ea5d2adc0fe3f49906fef48ae9 3f9c1d9c83a6704e18d5a7
Number 28:
b5ef3c5dac4be24ed7e4f9dddb977ebc6441738004a547939b5b689de7c50f98b93994e905bcbc ef896ac583895115f5891bbedd9d20c4d0bc9c656b3ec2c9379636d0a3420e333161860de3b57d 5677fbf415031098d7de8f1259e637e4ba31105b92c94bdaed82753b06b780cfe2fbec9e2034a 3018b8351bd2e2f1c614e7
Number 29:
baacd9fc6c4eaeaddc08383ab43de502fa0dd822f5fd6b958d966b8a8d2e1c2b304fe6a9c1640d d325e2372fdbebd9125f6c179a2aee91ab4f527acc6241691a15999d4de50df792203c3e7048f5a26729ab56cde31a050de313a7fe7b343586ac9147c1116ba17828331e930d13c218155f00703b f1c1f5e4170e2b81f59d9
Number 30:
b776876773cabe517edf254f8a1fd015dea55d1e1e1e2597abf583639b541a0fc85bbd6be5563 09fc4d486c12ddf63f24a34366a85e14eb30b6af3e52200d0e755b03fee2360446507b0ebce021e443b13e1411af11466dadc994e1733fc0dd24347e097d1bab5b938b67de888f78a1cd63d34e45a68816b4aa8a566a12aaad
Number 31:
d59664b6fad8a1c046711eat00124c8ca2d771a7f640ce32cb65238a92d199f3ab005863c97d 25d7794560a5246e13bb7b3d7696d63a4575ca5db90596c885b1a13f384710c6d5170af7b4d 73959a2116df24c8e4daf45bdcd62c4ff3d97b755bf022dd2b62025ee086e9942fa000761678 9b5e0e0c39398526a96794640929

51. A data processing device having data storage means, said data storage means having stored thereon computer readable code for executing a method for retrieving data from a networked information source, said method comprising the steps of:
accessing a specific file corresponding to said networked information source;
locating a portion of said specific file said portion, denoting a network address for said networked information source;
communicating with said networked information source using said network address; and
retrieving contents of a data file located at said network address, said data file containing said data, said data relating to information items stored at said networked information source.

52. Computer readable media having stored thereon computer readable and computer executable code for executing a method for retrieving data from a first networked information source, said method comprising the steps of:
accessing a specific file corresponding to said first networked information source;
locating a portion of said specific file denoting a network address for said first networked information source;
communicating with said first networked information source using said network address; and
retrieving contents of a data file located at said network address, said data file containing said data, said data relating to information items stored at a second networked information source.

53. Computer readable media according to claim 52 wherein said first networked information source is the same as said second networked information source.

54. Computer readable media according to claim 53 wherein said specific file comprises:
a source field containing a network address, said network address being a location in a network where said data is stored;
a script field containing instructions for said application on how said data is to be processed.

55. A communications signal for transporting a copy of a software application from a first computing device to a second computing device, said software application comprising:
a script engine module for interpreting said first data, said first data including a network location for said first one of said networked information sources;
a communications module for retrieving second data from said first one of said networked information sources, said second data relating to information items stored on a second one of said networked information sources;
a graphical user interface module for presenting at least a portion of said second data to a user,
wherein the or each script file corresponds to said second one of said networked information sources.

56. A communications signal according to claim 55 wherein said first computing device is a computer capable of connecting to a server on a network and said second computing device is capable of connecting to said server and of processing data.

57. A communications signal according to claim 56 wherein said second computing device is chosen from a group consisting of:
a personal digital assistant;
a personal computer;
a network server connected to the Internet;
a data processing device capable of accessing a network;
desktop computers;
Internet appliances;
handheld computing devices;
Personal Digital Assistants (PDA);
cellular telephones (mobile telephones);
set top boxes for televisions; and
automotive based computing devices.
